(19) United States
(12) Patent Application Publication
(10) Pub. No.: US 2013/0058379 A1
(43) Pub. Date: Mar. 7, 2013

(54) COMMUNICATION APPARATUS AND COMMUNICATION METHOD IN WIRELESS POWER TRANSMISSION SYSTEM

(71) Applicants: Nam Yun KIM, Seoul (KR); Sang Wook KWON, Seongnam-si (KR)

(72) Inventors: Nam Yun KIM, Seoul (KR); Sang Wook KWON, Seongnam-si (KR)

(73) Assignee: SAMSUNG ELECTRONICS CO., LTD., Suwon-si (KR)

(21) Appl. No.: 13/603,191

(22) Filed: Sep. 4, 2012

(30) Foreign Application Priority Data
Sep. 5, 2011 (KR) 10-2011-0089396
Oct. 27, 2011 (KR) 10-2011-0110530

(51) Int. Cl. H04B 7/00; H04B 1/707

(52) U.S. Cl. 375/146; 455/69; 375/E01.002

(57) ABSTRACT

An apparatus and method to perform communication in a wireless power transmission system are provided. When a communication channel is selected from channels excluding a channel used in wireless power transmission, a communication apparatus and method transmit, using a frequency of the communication channel, a channel seizure signal, an access standard instruction, and a state information signal indicating an operating mode of a source. When a response signal corresponding to the access standard instruction is received from a target, the communication apparatus and method determine a control identifier (ID) of the target.

### CROSS-REFERENCE TO RELATED APPLICATION(S)

This application claims the benefit under 35 U.S.C. §119(a) of Korean Patent Application No. 10-2011-0089396, filed on Sep. 5, 2011, and Korean Patent Application No. 10-2011-0110530, filed on Oct. 27, 2011, in the Korean Intellectual Property Office, the entire disclosures of which are each incorporated herein by reference for all purposes.

### BACKGROUND

1. Field

The following description relates to an apparatus and method to perform a communication in a wireless power transmission system.

2. Description of Related Art

Researches on wireless power transmission are striving to overcome inconveniences of wired power supplies and the limited capacity of conventional batteries, due to an explosive increase in various electronic devices including electric vehicles, mobile devices, and similar devices. One wireless power transmission technology uses resonance characteristics of radio frequency (RF) devices. For example, a wireless power transmission system using resonance characteristics may include a source configured to supply power, and a target configured to receive supplied power. To efficiently transmit power from the source to the target, the source and the target need to exchange information on a state of the source and information on a state of the target. As a result of the increase in need to transmit power from the source to the target, there is a demand to perform efficient communication between the source and the target.

### SUMMARY

In accordance with an illustrative example, there is provided communication apparatus in a wireless power transmission system. The communication apparatus includes a communication unit configured to transmit a state information signal using a frequency of a communication channel, wherein the communication channel is selected from channels excluding a channel used in wireless power transmission, and the state information signal includes an operating mode of a source, and a controller configured to determine a control identifier (ID) of a target when a response signal corresponding to an access standard instruction is received from the target.

The communication unit is further configured to transmit a channel seizure signal and the access standard instruction using the frequency of the communication channel, wherein the channel seizure signal includes a continuous wave (CW) signal at a magnitude and power higher than a signal of a direct-sequence spread spectrum (DSSS).

The communication unit continues to transmit the channel seizure signal until a communication with the target is terminated.

The communication unit is further configured to transmit the determined control ID to the target, receive a response signal indicating reception of the determined control ID from the target, transmit a target information request signal to request information from the target, and receive a target information response signal including the information from the target.

The controller is further configured to determine an initial wireless power to be transmitted to the target based on the information from the target and information on an efficiency of a source resonator.

The communication apparatus further includes a power transmitter to wirelessly transmit the determined initial wireless power through a magnetic coupling between the source resonator and a target resonator.

The communication unit is further configured to transmit a charging information request signal to request information regarding a power transferred to a load at the target, and receive, from the target a charging information response signal including the information regarding the transferred power.

The controller is further configured to compare the information regarding the transferred power with a power required by the load at the target, and determine a power to be transmitted to the target based on the information on the efficiency of the source resonator.

When the target is detected in a wireless power transmission region of the source, the power transmitter transmits a wake-up power required for communication with the target.

The communication unit is further configured to transmit a wireless power transmission frame, and wherein a frame payload of a medium access control (MAC) layer of the wireless power transmission frame includes a start of text (STX) field, a source (SRC) field, a destination (DST) field, a command (CMD) field, a length (LEN) field, a data field, an end of text (ETX) field, and a checksum (CS) field.

The CMD field includes at least one of a target reset instruction, an input voltage/current request instruction, an output voltage/current request instruction, a target state request instruction, a target charging control instruction, an access standard instruction, a control ID assignment instruction, a target system configuration block (SCB) information request instruction, and a channel change request instruction.

The controller is further configured to detect a change in a power output from a power amplifier included in the source, and determines that the load at the target has changed, and wherein the communication unit is further configured to transmit a charging information request signal to request information regarding a power transferred to the load at the target, and receive, from the target, a charging information response signal including the information regarding the transferred power.

When charging of the load is complete, the controller is further configured to generate a target charging control signal to open electrical connection between the target and the load to prevent additional power from being transferred to the load.

The controller is further configured to determine whether the target is located in the wireless power transmission region of the source based on whether a response signal is received in response to a charging information request signal transmitted in real time to the target.

When the controller detects the change in the power output from the power amplifier in the source is detected, the controller is further configured to attempt to communicate with the target and determine that the target is located in the wireless power transmission region when a response signal is received from the target.

When a movement of the target is detected by an external sensor, the controller is further configured to attempt to communicate with the target, and determine that the target is located in the wireless power transmission region when a response signal is received from the target.

When a power is supplied, the controller is further configured to perform basic hardware initialization, reads information from a system configuration block (SCB), acquire information, which includes a serial number of the source, a maximum number of targets accessible to the source, a power transmission parameter, and a frequency search channel, and control a communication output in the frequency search channel.

The SCB includes a region indicating a manufacturer of a product, a region used to classify products into a source and a target, a region indicating a unique ID of a product, a region indicating a model type, and a region indicating a serial number.

The controller is further configured to control the source and the target to be operated in a master mode and a slave mode, respectively.

When a channel accessed by the source has changed to another channel due to interference with the channel, the communication unit is further configured to transmit to the target a broadcasting instruction not requiring a response signal from the target so that the target changes a channel to the other channel.

The communication apparatus also includes a first light-emitting diode (LED) indicator, a second LED indicator, and a third LED indicator, each displaying different colors, wherein, when a power is supplied to the source and when hardware initialization is normally performed, the first LED indicator is turned on, wherein, when the hardware initialization is abnormally performed or when abnormality occurs in an operation of the source, the second LED indicator flickers, wherein, when the target is being charged by the source, the second LED indicator is turned on, and wherein, when a communication error between the source and the target occurs, the third LED indicator flickers.

In accordance with an illustrative example, there is provided a communication apparatus in a wireless power transmission system, the communication apparatus including a communication unit configured to receive a channel seizure signal, an access standard instruction, and a state information signal using a frequency of a communication channel, and to transmit a response signal corresponding to the access standard instruction, wherein the state information signal includes an operating mode of a source, and a controller configured to determine the communication channel to be a channel used for communication between the source and a target based on the received channel seizure signal, and to generate a response signal corresponding to the access standard instruction.

When a communication being performed between the source and another target in an access mode or a charging mode is verified based on the state information signal, the controller is further configured to wait for communication with another source.

The communication unit is further configured to receive a control identifier (ID) from the source, transmit a response signal indicating reception of the control ID, receive a target information request signal to request target information, and transmit a target information response signal including the target information.

In accordance with an illustrative example, there is provided a power receiving unit configured to wirelessly receive an initial wireless power through a magnetic coupling between a source resonator and a target resonator, wherein the initial wireless power is determined based on the target information.

When the controller determines that charging of a load at the target is determined to be complete, the controller is further configured to open an electrical connection between the target and the load to prevent a power from being transferred to the load.

The controller is awakes, the controller is further configured to perform basic hardware initialization, and acquire a serial number of a target, a battery type, a power transmission parameter, and a parameter of a search channel from a system configuration block (SCB).

In accordance with an illustrative example, there is provided a first light-emitting diode (LED) indicator, a second LED indicator, and a third LED indicator, each displaying different colors, wherein, when a wake-up power is supplied to the target and when hardware initialization is normally performed, the first LED indicator is turned on, wherein, when the hardware initialization is abnormally performed or when abnormality occurs in an operation of the target, the second LED indicator flickers, wherein, when the target is being charged, the second LED indicator is turned on, and wherein, when a communication error between the source and the target occurs, the third LED indicator flickers.

In accordance with an illustrative example, there is provided a communication apparatus in a wireless power transmission system, the communication apparatus including a communication unit configured to transmit a channel seizure signal, a first access standard instruction, and a first state information signal using a frequency of a communication channel, wherein the communication channel is selected from channels excluding a channel used in wireless power transmission, and the first state information signal includes an operating mode of a source, and a controller configured to receive a response signal corresponding to the first access standard instruction from a first target to determine a control identifier (ID) of the first target, wherein, when the determined control ID of the first target is transmitted, the communication unit is further configured to transmit the channel seizure signal, a second access standard instruction, and a second state information signal using the frequency of the communication channel, and wherein, when a response signal corresponding to the second access standard instruction is received from a second target, the controller is further configured to determine a control ID of the second target.

The communication unit is further configured to transmit a first charging information request signal to request information regarding a power transferred to a load of the first target, and receive from the first target a first charging information response signal including the information regarding the transferred power, and wherein, when the first charging information response signal is received, the communication unit is further configured to transmit a second charging information request signal to request information regarding a power transferred to a load of the second target, and receive, from the second target, a second charging information response signal including the information regarding the transferred power.

The communication unit is further configured to transmit the first charging information request signal, together with a third state information signal indicating that the source is operated in a charging mode to transmit a power to the first target, and transmit the second charging information request signal, together with a fourth state information signal indicating that the source is operated in the charging mode to transmit a power to the second target.

The controller is further configured to compare the information regarding the power transferred to the load of the first target with a power required by the load of the first target, compare the information regarding the power transferred to the load of the second target with a power required by the load of the second target, and determine a power to be transmitted.

In accordance with an illustrative example, there is provided a communication method for a wireless power transmission system, the communication method including selecting a communication channel from channels excluding a channel used in wireless power transmission, transmitting a state information signal using a frequency of a communication channel, wherein the state information signal includes an operating mode of a source, and determining a control identifier (ID) of a target when a response signal corresponding to the access standard instruction is received from the target.

The method also includes configuring a channel seizure signal to comprise a continuous wave (CW) signal at a magnitude and power higher than a signal of a direct-sequence spread spectrum (DSSS), and transmitting the channel seizure signal and an access standard instruction using the frequency of the communication channel.

The method also includes continuously transmitting the channel seizure signal until a communication with the target is terminated.

The method also includes transmitting the determined control ID to the target, receiving a response signal indicating reception of the determined control ID from the target, transmitting a target information request signal to request information from the target, and receiving a target information response signal including the information from the target.

The method also includes determining an initial wireless power to be transmitted to the target based on the information from the target and information on an efficiency of a source resonator.

The method also includes wirelessly transmitting the determined initial wireless power through a magnetic coupling between the source resonator and a target resonator.

The method also includes transmitting a charging information request signal to request information regarding a power transferred to a load at the target, and receiving from the target a charging information response signal including the information regarding the transferred power.

The method also includes comparing the information regarding the transferred power with a power required by the load at the target, and determining a power to be transmitted to the target based on the information on the efficiency of the source resonator.

The method also includes transmitting a wake-up power to communicate with the target when the target is detected in a wireless power transmission region of the source.

The method also includes detecting a change in a power output from a power amplifier included in the source, and determines that the load at the target has changed, transmitting a charging information request signal to request information regarding a power transferred to the load at the target, and receiving, from the target, a charging information response signal including the information regarding the transferred power.

The method also includes when charging of the load is complete, generating a target charging control signal to open electrical connection between the target and the load to prevent additional power from being transferred to the load.

The method also includes determining whether the target is located in the wireless power transmission region of the source based on whether a response signal is received in response to a charging information request signal transmitted in real time to the target.

The method also includes when the controller detects the change in the power output from the power amplifier in the source is detected, attempting to communicate with the target, and determining that the target is located in the wireless power transmission region when a response signal is received from the target.

The method also includes when a movement of the target is detected by an external sensor, attempting to communicate with the target, and determining that the target is located in the wireless power transmission region when a response signal is received from the target.

The method also includes when a channel accessed by the source has changed to another channel due to interference with the channel, transmitting to the target a broadcasting instruction not requiring a response signal from the target so that the target changes a channel to the other channel.

Other features and aspects will be apparent from the following detailed description, the drawings, and the claims.

### BRIEF DESCRIPTION OF THE DRAWINGS

FIG. 1 is a diagram illustrating an example of a wireless power transmission system.

FIG. 2 is a block diagram illustrating an example of a communication apparatus in the wireless power transmission system.

FIG. 3 is a block diagram illustrating another example of the communication apparatus in the wireless power transmission system.

FIG. 4 is a diagram illustrating an example of a format of a frame transmitted by the communication apparatus in the wireless power transmission system.

FIG. 5 is a diagram illustrating an example of an access mode between a source and a single target in the wireless power transmission system.

FIG. 6 is a diagram illustrating an example in which a load at a target has changed in the wireless power transmission system.

FIG. 7 is a diagram illustrating an example of an operation performed at the source when the load at the target changes in a charging mode in the wireless power transmission system.

FIG. 8 is a diagram illustrating an example in which the target is removed while charging in the wireless power transmission system.

FIG. 9 is a diagram illustrating an example of an operation performed at the source when the target is removed while charging in the wireless power transmission system.

FIG. 10 is a diagram illustrating an example of an access mode between the source and a plurality of targets in the wireless power transmission system.

FIG. 11 is a diagram illustrating an example in which the source verifies the plurality of targets and sets supplied power in the wireless power transmission system.

FIG. 12 is a diagram illustrating an example in which charging of one of the plurality of targets is completed in the wireless power transmission system.

FIG. 13 is a diagram illustrating an example of operations of the source and the plurality of targets while charging one of the targets is completed in the wireless power transmission system.

FIG. 14 is a diagram illustrating an example in which one of the plurality of targets is removed while the targets are charged in the wireless power transmission system.

FIG. 15 is a diagram illustrating an example of operations between the source and the plurality of targets when one of the targets is removed while the targets are charged in the wireless power transmission system.

FIG. 16 is a block diagram illustrating still another example of a communication apparatus in the wireless power transmission system.

FIGS. 17A through 17B are diagrams illustrating examples of a distribution of a magnetic field in a feeder and a resonator.

FIGS. 18A and 18B are diagrams illustrating an example of the wireless power transmitter.

FIG. 19A is a diagram illustrating an example of a distribution of a magnetic field within the resonator based on feeding to the feeder.

FIG. 19B is a diagram illustrating examples of equivalent circuits of the feeder and the resonator.

FIG. 20 is a diagram illustrating an example of an electric vehicle charging system.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

A scheme to perform communication between a source and a target may include an in-band communication scheme and an out-band communication scheme. The in-band communication scheme is a communication performed between the source and the target in the same frequency band as used for power transmission. The out-band communication scheme is a communication performed between the source and the target in a separate frequency band, different from the frequency band used for power transmission.

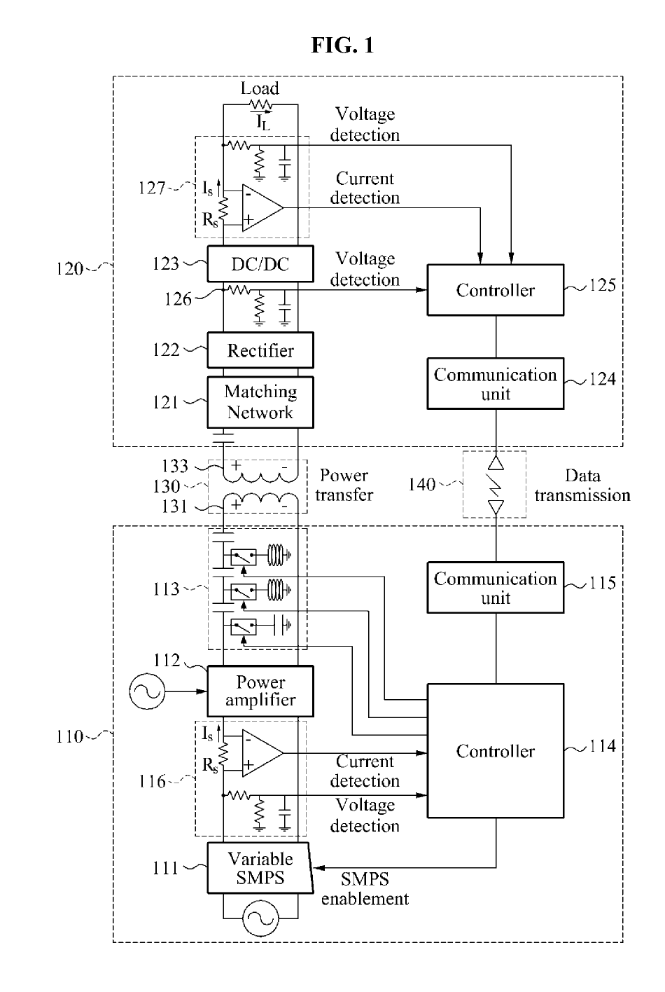

FIG. 1 illustrates an example of a wireless power transmission system.

Referring to FIG. 1, the wireless power transmission system includes a source 110 and a target 120. The source 110 may refer to a device configured to supply wireless power, and may include all electronic devices enabling power supply, for example a pad, a terminal, a television (TV), and the like. The target 120 may refer to a device configured to receive supplied wireless power, and may include all electronic devices requiring power, for example a terminal, a TV, a vehicle, a washing machine, a radio, an electric light, and or any other type of device known to one of ordinary skill in the art.

The source 110 includes a variable switching mode power supply (SMPS) 111, a power amplifier 112, a matching network 113, a controller 114, and a communication unit 115.

The variable SMPS 111 generates direct current (DC) voltage by switching alternating current (AC) voltage in a band of tens of hertz (Hz) output from a power supply. The variable SMPS 111 outputs DC voltage at a predetermined level, or adjusts an output level of DC voltage based on the control of the controller 114.

The variable SMPS 111 controls supplied voltage based on a level of power output from the power amplifier 112 so that the power amplifier 112 may be operated in a saturation region with high efficiency at all times, and may enable a maximum efficiency to be maintained at all levels of the output power. The power amplifier 112 may have class-E features.

For example, when a common SMPS is used instead of the variable SMPS 111, a variable DC-to-DC (DC/DC) converter also needs to be used, thereby requiring more hardware components. In this example, the common SMPS and the variable DC/DC converter may control supplied voltage based on the level of the power output from the power amplifier 112. As a result, the power amplifier 112 would be operated in the saturation region with high efficiency at all times, and enable the maximum efficiency to be maintained at all levels of the output power.

A power detector 116 detects output current and output voltage of the variable SMPS 111, and transfers, to the controller 114 information on the detected current and the detected output voltage. Additionally, the power detector 116 detects input current and input voltage of the power amplifier 112.

The power amplifier 112 generates power by converting DC voltage at a predetermined level to AC voltage using a switching pulse signal in a band of a few megahertz (MHz) to tens of MHz. Accordingly, the power amplifier 112 converts DC voltage supplied to the power amplifier 112 to AC voltage using a reference resonant frequency F_{Ref}. The power amplifier 112 generates communication power used for communication with or charging power used for charging a plurality of target devices.

In one illustrative example, the communication power refers to a low power of 0.1 milliwatt (mW) to 1 mW. In the alternative, the charging power may refer to a high power of 1 mW to 200 W consumed by a device load of a target device. In various examples described herein, the term “charging” may refer to supplying power to a unit or element that is configured to charge power. Additionally, the term “charging” may refer to supplying power to a unit or element that is configured to consume power. The units or elements may include, for example, batteries, displays, sound output circuits, main processors, and various sensors.

Also, the term “reference resonant frequency” may refer to a resonant frequency that is used by the source 110. Additionally, the term “tracking frequency” may refer to a resonant frequency that is adjusted by a preset scheme.

The controller 114 detects a reflected wave of the communication power or the charging power, and detects mismatching that may occur between a target resonator 133 and a source resonator 131 based on the detected reflected wave. To detect the mismatching, for example, the controller 114 may detect an envelope of the reflected wave, a power amount of the reflected wave, or any other type of reflected wave characteristic.

Under the control of the controller 114, the matching network 113 compensates for impedance mismatching between the source resonator 131 and the target resonator 133 to be optimally matched. The matching network 113 is connected to the controller 114 through a switch, which is based on a combination of a capacitor and an inductor.

The controller 114 computes a voltage standing wave ratio (VSWR), based on a voltage level of the reflected wave, and based on a level of an output voltage of the source resonator 131 or the power amplifier 112. For example, when the VSWR is greater than a predetermined value, the controller 114 determines that mismatching is detected. In this example, the controller 114 computes a power transmission efficiency for each of N tracking frequencies, determines a tracking frequency F_{Best} with best power transmission efficiency among the N tracking frequencies, and adjusts the reference resonant frequency F_{Ref} to the tracking frequency F_{Best}. In various examples, the N tracking frequencies may be set in advance.

The controller 114 adjusts a frequency of a switching pulse signal. The controller 114 determines the frequency of the switching pulse signal. For example, by controlling the power amplifier 112, the controller 114 generates a modulation signal to be transmitted to the target 120. In other words, the communication unit 115 transmits a variety of data 140 to the target 120 using in-band communication. The controller 114 detects a reflected wave, and demodulates a signal received from the target 120 through an envelope of the detected reflected wave.

The controller 114 generates a modulation signal for in-band communication using various processes. For example, the controller 114 generates the modulation signal by turning on or off a switching pulse signal, by performing delta-sigma modulation or by performing any other type of modulation mechanism. Additionally, the controller 114 generates a pulse-width modulation (PWM) signal with a predetermined envelope.

The communication unit 115 performs out-band communication employing a communication channel. The communication unit 115 may include a communication module, such as one configured to process ZigBee, Bluetooth, Wi-Fi, or any other type of standard. The communication unit 115 may transmit the data 140 to the target 120 through the out-band communication.

The source resonator 131 transfers an electromagnetic energy 130 to the target resonator 133. For example, the source resonator 131 transfers the communication power or charging power to the target 120 using magnetic coupling with the target resonator 133.

As illustrated in FIG. 1, the target 120 includes a matching network 121, a rectifier 122, a DC/DC converter 123, a communication unit 124, and a controller 125.

The target resonator 133 receives the electromagnetic energy 130 from the source resonator 131. For example, the target resonator 133 receives the communication power or charging power from the source 110, through the magnetic coupling with the source resonator 131. Additionally, the target resonator 133 receives the data 140 from the source 110 through the in-band communication.

The matching network 121 matches an input impedance viewed from the source 110 to an output impedance viewed from a load in the target 120. The matching network 121 may be configured with a combination of a capacitor and an inductor.

The rectifier 122 generates DC voltage by rectifying AC voltage. For example, the AC voltage is received from the target resonator 133. The rectifier 122 may be a full-wave rectifier or a combination of half-wave rectifiers.

The DC/DC converter 123 adjusts a level of the DC voltage that is output from the rectifier 122, based on a capacity required by the load. As an example, the DC/DC converter 123 may adjust the level of the DC voltage output from the rectifier 122 from 3 volts (V) to 10 V.

The power detector 127 detects a voltage from an input terminal 126 through the DC/DC converter 123. The power detector 127 also detects current and voltage from an output terminal of the DC/DC converter 123. The detected voltage from the input terminal 126 may be used to compute a transmission efficiency of power received from the source 110. Additionally, the controller 125 may use the detected current and the detected voltage from the output terminal of the DC/DC converter 123 to compute an amount of power to be transferred to the load. The controller 114 of the source 110 may determine an amount of power the source 110 may need to transmit based on power required by the load and power transferred to the load. For example, power from the output terminal of the DC/DC converter 123 is computed, as a function of the detected current and voltage from the output terminal of the DC/DC converter 123, and is transferred through the communication unit 124 to the source 110. The source 110 may then compute an amount of power that needs to be transmitted.

The communication unit 124 performs in-band communication to transmit or receive data using a resonance frequency. During the in-band communication, the controller 125 demodulates a received signal by detecting a signal between the target resonator 133 and the rectifier 122, or by detecting an output signal of the rectifier 122. In other words, the controller 125 demodulates a message received using the in-band communication. Additionally, the controller 125 adjusts an impedance of the target resonator 133 using the matching network 121 to modulate a signal to be transmitted to the source 110. For example, the controller 125 increases the impedance of the target resonator 133 to enable a detection of a reflected wave at the controller 114 of the source 110. Depending on whether the reflected wave is detected, the controller 114 may detect a binary number, for example “0” or “1.” For example, if the controller 114 detects the reflected wave, the controller 114 outputs “1” as the binary number. If the controller 114 does not detect the reflected wave, the controller 114 outputs “0” as the binary number.

The communication unit 124 transmits a response message to the communication unit 115 of the source 110. For example, the response message may include a “type of a corresponding target,” “information about a manufacturer of a corresponding target,” “a model name of a corresponding target,” a “battery type of a corresponding target,” a “scheme of charging a corresponding target,” an “impedance value of a load of a corresponding target,” “information on characteristics of a target resonator of a corresponding target,” “information on a frequency band used by a corresponding target,” an “amount of a power consumed by a corresponding target,” an “identifier (ID) of a corresponding target,” “information on version or standard of a corresponding target,” or any other similar messages.

The communication unit 124 performs out-band communication using a communication channel. For example, the communication unit 124 may include a communication module, such as one configured to process ZigBee, Bluetooth, Wi-Fi, or any other similar standard. The communication unit 124 may transmit or receive the data 140 to or from the source 110 using the out-band communication.

The communication unit 124 receives a wake-up request message from the source 110. The power detector 127 detects an amount of power received at the target resonator 133. The communication unit 124, in turn, transmits information on the detected amount of power to the source 110. Information on the detected amount may include, for example, an input voltage value and an input current value of the rectifier 122, an output voltage value and an output current value of the rectifier 122, an output voltage value and an output current value of the DC/DC converter 123, or any other similar information.

In FIG. 1, the controller 114 may set a resonance bandwidth of the source resonator 131. Based on a setting of the resonance bandwidth of the source resonator 131, a Q-factor of the source resonator 131 may be determined.

Additionally, the controller 125 sets a resonance bandwidth of the target resonator 133. Based on a setting of the resonance bandwidth of the target resonator 133, a Q-factor of the target resonator 133 may be determined. For example, the resonance bandwidth of the source resonator 131 may be set to be wider or narrower than the resonance bandwidth of the target resonator 133.

In one illustrative example, the source 110 and the target 120 communicate with each other in order to share information about the resonance bandwidth of the source resonator 131 and the resonance bandwidth of the target resonator 133. In an example in which power desired or required by the target device 120 is higher than a reference value, the Q-factor of the source resonator 131 may be set to a value greater than “100.” In another example in which the power desired or required by the target 120 is lower than the reference value, the Q-factor of the source resonator 131 may be set to a value less than “100”. Other illustrative samples for the value may be used to set the Q-factor.

In a wireless power transmission employing a resonance scheme, the resonance bandwidth may be an important factor. A Q-factor may consider at least one of the following: a change in a distance between the source resonator 131 and the target resonator 133, a change in the resonance impedance, impedance mismatching, a reflected signal, and other similar types of changes. The change in the Q-factor may be represented by Qt. In this example, Qt may have an inverse-proportional relationship with the resonance bandwidth, as given by Equation 1.

$$\begin{matrix}\frac{Δ f}{{f}_{0}} = \frac{1}{Qt} \\ = {Γ}_{S , D} + \frac{1}{{BW}_{S}} + \frac{1}{{BW}_{D}}\end{matrix} \qquad [ Equation 1 ]$$

In Equation 1, fₒ denotes a central frequency, denotes a change in a bandwidth, Γ_{S,D} denotes a reflection loss between the source resonator 131 and the target resonator 133, BW_{S} denotes the resonance bandwidth of the source resonator 131, and BW_{D} denotes the resonance bandwidth of the target resonator 133.

An efficiency U of the wireless power transmission may be defined, as given in the example of Equation 2.

$$U = \frac{κ}{\sqrt{{Γ}_{S} {Γ}_{D}}} = \frac{{ω}_{0} M}{\sqrt{{R}_{S} {R}_{D}}} = \frac{\sqrt{{Q}_{S} {Q}_{D}}}{{Q}_{κ}} \qquad [ Equation 2 ]$$

In Equation 2, κ denotes a coupling coefficient of energy coupling between the source resonator 131 and the target resonator 133, Γ_{S} denotes a reflection coefficient in the source resonator 131, Γ_{D} denotes a reflection coefficient in the target resonator 133, ω₀ denotes a resonant frequency, M denotes a mutual inductance between the source resonator 131 and the target resonator 133, R_{S} denotes an impedance of the source resonator 131, R_{D} denotes an impedance of the target resonator 133, Qs denotes the Q-factor of the source resonator 131, Q_{D} denotes the Q-factor of the target resonator 133, and Q_{K} denotes a Q-factor of the energy coupling between the source resonator 131 and the target resonator 133.

Referring to Equation 2, the Q-factors may have high relevance to the efficiency of the wireless power transmission. Accordingly, to increase an efficiency of the wireless power transmission, the Q-factors may be set to high values. For example, when the Q-factors Q_{S} and Q_{D} are set to extremely high values, the efficiency of the wireless power transmission may be reduced due to a change in the coupling coefficient κ, a change in a distance between the source resonator 131 and the target resonator 133, a change in the resonance impedance, impedance mismatching, and other types of similar changes or mismatches.

Additionally, to increase the efficiency of the wireless power transmission, when the resonance bandwidth of the source resonator 131 and the resonance bandwidth of the target resonator 133 are set to be excessively narrow, impedance mismatching and other types of similar changes or mismatches may occur due to an external change or effect, even if such external effect is relatively small. Considering the impedance mismatching, Equation 1 may be represented as given in Equation 3.

$$\frac{Δ f}{{f}_{0}} = \frac{\sqrt{VSWR} - 1}{Qt \sqrt{VSWR}} \qquad [ Equation 3 ]$$

In an example in which an unbalanced relationship of a resonance bandwidth or a bandwidth of an impedance matching frequency between the source resonator 131 and the target resonator 133 is maintained, a reduction in efficiency of the wireless power transmission may be prevented. The reduction in efficiency may be a result of a change in the coupling coefficient κ, a change in the distance between the source resonator 131 and the target resonator 133, a change in the resonance impedance, impedance mismatching, and other types of similar changes.

Based on Equations 1 and 3, an unbalanced relationship between the Q-factors Q_{S} and Q_{D} may be maintained in an example in which the unbalanced relationship of the resonance bandwidth or the bandwidth of the impedance matching frequency between the source resonator 131 and the target resonator 133 is maintained.

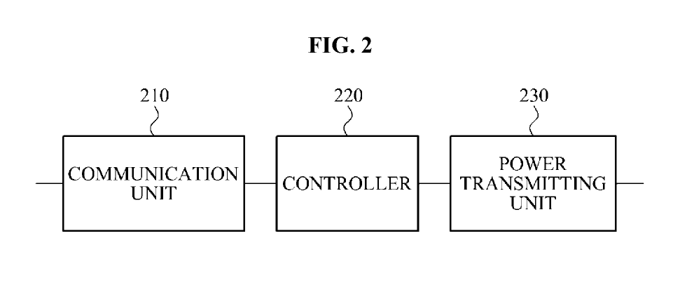

FIG. 2 illustrates an example of a communication apparatus in a wireless power transmission system.

Referring to FIG. 2, the communication apparatus includes a communication unit 210, a controller 220, and a power transmitting unit or a power transmitter 230. The communication apparatus of FIG. 2 may correspond to the source 110 in the wireless power transmission system.

In one example, the controller 220 selects a communication channel from multiple channels, excluding a channel used in wireless power transmission. Using a communication frequency of the communication channel, the communication unit 210 transmits a channel seizure signal, an access standard instruction, and a state information signal.

The channel seizure signal may have a predetermined magnitude. For example, the channel seizure signal may be a continuous wave (CW) signal with a predetermined magnitude and a power higher than a signal of a direct-sequence spread spectrum (DSSS). The channel seizure signal may be modulated using a predetermined modulation scheme including, but not limited to, Frequency Shift Keyed (FSK), Gaussian Minimum Shift Keyed (GMSK), Phase Shift Keyed (PSK), Binary Phase Shift Keyed (BPSK), Quadrature Phase Shift Keyed (QPSK), and Offset Quadrature Phase Shift Keyed (O-QPSK).

The access standard instruction may include information used for compatibility between the source and the target. The access standard instruction may include, but is not limited to, a call parameter and a call argument used to identify targets. For example, when a target has the same identifying parameter as a call parameter, a response signal may be transmitted.

The state information signal may indicate an operating mode of the source. The operating mode may include, but is not limited to, a standby mode, an access mode, and a charging mode.

For example, when power is supplied, a source may perform basic hardware initialization, may read information from a system configuration block (SCB), and may initialize system information. The system information may include, but is not limited to, a serial number of the source, a maximum number of targets accessible to the source, a power transmission parameter, a communication channel parameter, or any other type of parameter known to one of ordinary skill in the art.

The source may be operated in a master mode, and the target may be operated in a slave mode. Accordingly, the source may function as a subject for each control state, and the target may provide state information based on a demand from the source. When abnormality occurs during charging of the target, the target may automatically perform processing.

The SCB may support at least 8 bytes, and a capacity of the SCB may be increased based on a type of product and improvement of functions. The SCB may be divided into a system state information region and a unique product serial number region. For example, in an 8-byte structure, each information address may be set from SCB[7] to SCB[0]. An SCB of a source may be configured, as shown in Table 1.

| | Category | | Description |
|---|---|---|---|
| SCB[7] | Company ID | | Records manufacturer of product |
| | | | in form of numbers or characters, |
| | | | and is used to determine |
| | | | whether source and target are |
| | | | compatible during initial |
| | | | access. For example, SCB[7] |
| | | | may be set to ′0 × 01.′ |
| SCB[6] | Classification of | | Defines source as ′0 × 01.′ |
| | source and target | | |
| SCB[5] | Product ID | | 1. Indicates resonator efficiency |
| | | | using hexadecimal value. |
| | | | 2. Defines type of product, |
| | | | and defines maximum |
| | | | output, resonator size,or any |
| | | | other type of product identifier |
| | | | known to one of ordinary |
| | | | skill in the art. Indicates unique |
| | | | number of product |
| SCB[4] | Model | Class 1 | Indicates maximum number |
| | type | Class 2 | of targets to be accommodated in |
| | | Class 3 | source. If three SCBs exist, |
| | | Class 4 | SCB[4] may be ′0 × 03.′ |

| | | |
|---|---|---|
| SCB[3]~ | Serial number | Indicates unique serial |
| SCB[0] | | number of product in |
| | | manufacturing of product, |
| | | and sufficient length is |
| | | assigned to prevent unique serial |
| | | numbers from overlapping based on |
| | | production. If desired, year, |
| | | month, and day may be included. |

Models of a source may be classified, as shown in Table 2 below. As shown in Table 2, a class of the source may be determined based on a size of the source and a minimum power level of a power output from the source.

TABLE 2

| Class | Width (mm) | Length (mm) | Minimum power (W) |
|---|---|---|---|
| Class 1 | 40~60 | 40~60 | 6 |
| Class 2 | 50~90 | 50~90 | 10 |
| Class 3 | 80~180 | 100~250 | 24 |
| Class 4 | 140~200 | 150~300 | 46 |

An SCB of a target may include a region used to verify compatibility of the target. The region to verify compatibility of the target may include a region used to classify products, a region indicating a serial number and information for a unique charging function, and a region associated with compatibility. A serial number of the target may be used when a source assigns a control ID. The SCB may be implemented using a memory region of a processor or an external memory. The external memory may include various memory devices, for example, an electrically erasable programmable read-only memory (EEPROM), read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other readable storage medium known to one of ordinary skill in the art.

The SCB of the target may be configured as shown in Table 3.

TABLE 26

| | Category | | Description |
|---|---|---|---|
| SCB[7] | Company ID | | Indicates ID of manufacturer, |
| | | | for example, may be set |
| | | | to ′0 × 01.′ |
| SCB[6] | Classification of | | Defines target as ′0 × 00.′ |
| | source and target | | |
| SCB[5] | Product ID | | For example, mobile charger |
| | | | is defined as '0 x 01.' |
| SCB[4] | Battery | Class 1 | Indicates charging index using |
| | type | Class 2 | hexadecimal value. |
| | | Class 3 | That is, amount of power |
| | | Class 4 | required is defined and |
| | | Class 5 | applied. |

| | | |
|---|---|---|
| SCB[3]~ | Serial number | Unique number of product |
| SCB[0] | | |

A battery of the target may be classified as shown in Table 4 below. A class of the target may be determined based on a size of the target and a level of power required by the target.

TABLE 4

| Category | Width (mm) | Length (mm) | Required power (W) |
|---|---|---|---|
| Class 1 | 20 | 20 | ~1 |
| Class 2 | 40 | 40 | 1~3 |
| Class 3 | 40 | 60 | 3~6 |
| Class 4 | 120 | 120 | 6~12 |
| Class 5 | TBD | TBD | 12~TBD |

In the standby mode, the source may determine whether a charge command is received. In an example, when a start button is input, the source receives the charge command. In another example, when a target located within a predetermined distance from a source is detected, the source automatically receives the charge command. The source may check states of all channels that may be used for communication including receipt of the charge command. The source may measure a level of a received signal strength indicator (RSSI) for each channel and may determine whether each channel is available.

In an example, when the charge command is received, the source may be operated in the access mode. In another example, when the source is already being accessed by the target, the source may detect a level of a reflected wave. When the level of the reflected wave has a predefined value, the source may determine that another target exists and may be operated in the access mode.

When the target is detected first or when the charge command is received, the source transmits wake-up power to a power transmission channel. The source measures the level of the RSSI or link quality indicator (LQI) in the communication channel. When the level of the RSSI is measured to be equal to or greater than a reference value, the communication channel may be determined to be a currently used channel. The communication channel may then continue to search for a next channel until a channel with a value less than the reference value is found. When the channel is found, the source may fix the found channel and, based on a reference in the found channel, the source may transmit an access standard instruction. When targets respond to the access standard instruction, the source may assign control IDs to the targets in an order that the targets respond to the access standard instruction.

When at least one target is connected to the source, the source may transmit wake-up power via a power transmission channel. The source may transmit an access standard instruction to an additionally detected target using a communication channel that has already been determined. When the additionally detected target responds to the access standard instruction, the source may assign control IDs to the targets in an order that the targets respond to the access standard instruction.

When a control ID is assigned to a target, the source may be operated in the transmission mode. For instance, the source may receive from the target information regarding power the target requires. The information regarding the required power may be stored in an SCB of the target. The transmission mode may be defined to be set in a time period from a point in time in which the source transmits power to a point in time in which a battery of the target is completely charged and a charge control port of the target is blocked. In the transmission mode, the source may regularly receive information on a state of the target, voltage and current of an input terminal of the target, and voltage and current of an output terminal of the target. The source may regularly receive the information based on rules defined in advance for each product and for each model. The source may perform a control operation based on the received information.

When a response signal to the access standard instruction is received from the target, the controller 220 may determine a control ID of the target.

In one example, the communication unit 210 continues to transmit the channel seizure signal until the communication with the target is terminated. When the channel seizure signal is continuously transmitted during the communication with the target, other sources may detect the channel seizure signal in the communication channel. The other sources may also determine that the communication channel is being used.

In accordance with an aspect, the communication unit 210 transmits the control ID to the target. The communication unit 210 receives a response signal indicating reception of the control ID from the target. When the response signal is received, the communication unit 210 transmits a target information request signal. Subsequently, the communication unit 210 receives a target information response signal including information about the target from the target device. The information about the target may include, for example, a battery type of the target, a capacity of the target, power initially required by the target, and other similar characteristics or diagnostics of the target.

Based on the information of the target, the controller 220 determines initial wireless power that is to be transmitted to the target. Also, the controller 220 determines information on efficiency of a source resonator included in the source. The controller 220 determines the same amount of initial wireless power as an amount of power required by the target. An efficiency of power transferred by the source may be determined based on a position or direction of the target. In one example, the information on the efficiency of the source resonator refers to an efficiency of wireless power transmission based on a position of the target positioned above a source resonator in a pad-type source. Based on the power required by the target, the controller 220 determines the initial wireless power. The controller 220 also determines the efficiency of the source resonator based on an amount of power received by the target from the source resonator.

The power transmitting unit 230 wirelessly transmits the initial wireless power through magnetic coupling between the source resonator of the source and a target resonator of the target. Magnetic coupling may occur when a resonant frequency of the source resonator is identical to a resonant frequency of the target resonator and, as a result, the initial wireless power may be transferred.

The communication unit 210 transmits a charging information request signal, and receives a charging information response signal. Charging information may refer to information regarding power transferred to a load at the target.

The controller 220 compares the charging information with power required by the load at the target, and determines the power to be transmitted to the target by a difference between the required power and transferred power. The controller 220 determines the power to be transmitted to the target based on the charging information, the power required by the load at the target, and the information on the efficiency of the source resonator.

When a target is detected in a wireless power transmission region of the source, the power transmitting unit 230 transmits wake-up power required to communicate with the target. In response to a charging start command, the power transmitting unit 230 then transmits the wake-up power to the wireless power transmission region.

The communication unit 210 transmits a wireless power transmission frame to the target, through a communication channel. The wireless power transmission frame may be divided into a physical (PHY) layer and a medium access control (MAC) layer. A frame payload of the MAC layer may include a start of text (STX) field, a source (SRC) field, a destination (DST) field, a command (CMD) field, a length (LEN) field, a data field, an end of text (ETX) field, and a checksum (CS) field.

The STX field indicates a start of a packet. The SRC field indicates an address for a source. The DST field indicates an address for a target. The CMD field indicates an instruction transferred from the source to the target. The LEN field indicates a length of the data field or data. The data field includes data associated with an instruction. The EXT field indicates an end of a packet. The CS field is used to check an error of a packet.

The CMD field may include at least one of a target reset instruction, an input voltage/current request instruction, an output voltage/current request instruction, a target state request instruction, a target charging control instruction, an access standard instruction, a control ID assignment instruction, a target SCB information request instruction, and a channel change request instruction.

The target reset instruction may be used to reset a target. For example, when the target is completely charged, or when abnormality occurs in the target, a source may reset the target. In this example, when voltage and/or current of the target is maintained at a level above a predetermined level over a predetermined period of time, compared to power output from the source, the source determines that charging of the target is completed. The abnormality occurring in the target refers to an increase in a temperature of the target beyond an optimal temperature.

The input voltage/current request instruction is used to request a voltage value and/or a current value to an input terminal of the target; for example, a voltage value and/or a current value input to a rectifier or to a DC-DC converter.

The output voltage/current request instruction is used to request a voltage value and/or a current value of an output terminal of the target; for example, a voltage value and/or a current value output from a DC-DC converter.

The target state request instruction is applied differently based on a separately defined criterion. The target state request instruction is used to request a state of a target, for example, a state in which a temperature of a target lies beyond an optimal temperature range, a state in which the target is not charged with power for a predetermined period of time, and other similar types of states.

The target charging control instruction is used to turn on or off a port used to charge a load of a target.

The access standard instruction is associated with a rule in which a control ID is assigned by a source to a predetermined target. The access standard instruction may include a reference point, a call argument, and a movement argument. For example, control IDs may be assigned to targets with the same parameters, such as a call parameter, in an order that the targets respond to the access standard instruction.

The control ID assignment instruction may be used to assign a determined control ID to a target. For example, when a predetermined target to which a control ID is assigned does not continuously respond ‘M’ times, a source cancels assignment of the control ID to the predetermined target. In this example, ‘M’ is determined based on a situation of the predetermined target for each product.

The target SCB information request instruction may be used to request information stored in an SCB of a target. For example, based on the information stored in the SCB of the target, a source acquires a requirement to charge the target and a requirement to transmit power to the target.

The channel change request instruction may be used to request a change in a communication channel that is used for communication between a source and a target. For example, when a currently used channel is in an abnormal communication state, the source searches for a new channel, and requests the target to change the currently used channel to the new channel. In this example, the abnormal communication state may include, for example, a state in which there is no response to a request to state information of the target, a state in which an error occurs in a packet received from the target, and other similar types of states.

The controller 220 detects a change in an amount of power output from a power amplifier included in the source. The controller 220 determines that the load at the target has changed by detecting the change in the amount of the output power. When the load at the target has changed, the amount of power output from the power amplifier may also be changed due to impedance matching. When a change in the load at the target is detected, the communication unit 210 transmits a charging information request signal, and receives a charging information response signal. Charging information refers to information regarding power that is currently transferred to a load of a current target.

Based on the charging information, when charging of the load at the target is determined to be completed, the controller 220 generates a target charging control signal. The target charging control signal opens an electrical connection between the target and the load to prevent additional power from being transferred to the load.

The controller 220 determines that the target is located in the wireless power transmission region when a response signal is received in response to the charging information request signal, which is transmitted in real time. In other words, the controller 220 determines to remove the target when the charging information response signal is received. Additionally, the communication unit 210 may wait for a predetermined period of time until the charging information response signal is received.

For example, when the change in the amount of output power from the power amplifier is detected or when movement of the target is detected by an external sensor, the controller 220 controls the communication unit 210 to attempt to communicate with the target.

In this example, the controller 220 controls the communication unit 210 to transmit the charging information request signal. When a response signal is received from the target, the controller 220 determines that the target is located in the wireless power transmission region of the source. When the target is removed, the amount of output power from the power amplifier may be changed.

The communication unit 210 may transmit to the target an instruction to request a response, and an instruction not to request a response. The instruction not to request a response may be referred to as a ‘broadcasting instruction.’ For example, when a broadcasting instruction is received, the target does not transmit a response signal and may operate based on information in the broadcasting instruction. The broadcasting instruction may include, for example, a target reset instruction, a channel change request instruction, and the like. For example, when a communication channel changes due to interfering with the communication channel, the source individually transmits a channel change request instruction to a target with a registered control ID.

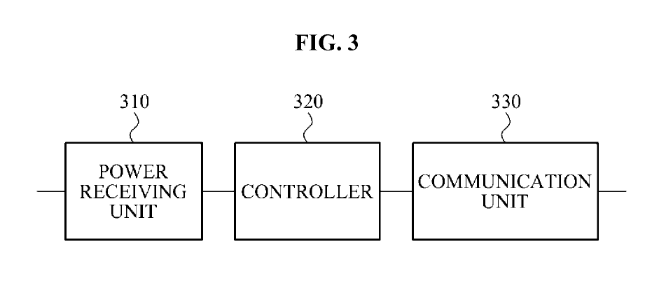

FIG. 3 illustrates another example of the communication apparatus in the wireless power transmission system.

Referring to FIG. 3, the communication apparatus includes a power receiving unit or power receiver 310, a controller 320, and a communication unit 330. The communication apparatus of FIG. 3 may correspond to a target in the wireless power transmission system.

The communication unit 330 receives from a source a channel seizure signal, an access standard instruction, and a state information signal, using a communication frequency of a communication channel.

The channel seizure signal includes a predetermined magnitude. The channel seizure signal is a CW signal that has a predetermined magnitude and has power higher than a signal of a DSSS. The channel seizure signal may be modulated using a predetermined modulation scheme.

The access standard instruction may include information used for compatibility between a source and a target. The access standard instruction may include a call parameter and a call argument used to identify targets. For example, when a target has the same identifying parameter as the call parameter, a response signal is transmitted.

The state information signal may indicate an operating mode of a source. The operating mode may include, for example, a standby mode, an access mode, and a charging mode.

The communication unit 330 transmits a response signal corresponding to the access standard instruction.

Based on the received channel seizure signal, the controller 320 determines the communication channel to be a channel to be used to communicate with the source. For example, when the channel seizure signal has a value equal to or greater than a reference value, the controller 320 determines the communication channel to be a channel used to communicate with the source. The controller 320 generates a response signal corresponding to the access standard instruction. For example, when a target has the same identifying parameter as the call parameter of the access standard instruction, the controller 320 transmits a response signal.

Based on the state information signal, the controller 320 verifies that the source communicates with another target in the access mode or the charging mode. The state information signal is received in a format of a wireless power transmission frame. The wireless power transmission frame may include an STX field, an SRC field, a DST field, a CMD field, a LEN field, a data field, an ETX field, and a CS field. The controller 320 verifies the operating mode of the source, or an address for a target that the source desires to communicate, based on the DST field, the CMD field, and the data field. For example, when the source is determined to be communicating with another target, the controller 320 waits to communicate with another source. The controller 320 searches for another channel. The target may attempt to access a source in another channel.

The communication unit 330 receives a control ID from the source. The communication unit 330 transmits a response signal indicating reception of the control ID. Additionally, the communication unit 330 receives a target information request signal, and transmits a target information response signal including information about the target. The information of the target may include, for example, a battery type of the target, a capacity of the target, power initially required by the target, and other similar type of information.

Through magnetic coupling between a source resonator and a target resonator, the power receiving unit 310 wirelessly receives initial wireless power. The initial wireless power is determined by the source based on the information from the target. The source resonator and the target resonator are included in the source and the target, respectively. When a resonant frequency of the source resonator is identical to a resonant frequency of the target resonator, magnetic coupling occurs and the initial wireless power is transferred.

When charging of a load at the target is determined to be completed, the controller 320 opens an electrical connection between the target and the load to prevent power from being transferred to the load.

The communication unit 330 receives a charging information request signal, and transmits a charging information response signal. Charging information refers to information regarding power transferred to the load at the target.

The controller 320 measures power transferred to the load at the target. The power transferred to the load at the target is computed based on voltage applied to both ends of the load and current flowing in the load. The controller 320 measures the voltage applied to both ends of the load and the current flowing in the load.

The communication unit 330 receives a wireless power transmission frame from the source through the communication channel. The wireless power transmission frame is classified at a PHY layer and a MAC layer. A frame payload of the MAC layer may include an STX field, an SRC field, a DST field, a CMD field, a LEN field, a data field, an ETX field, and a CS field.

The STX field indicates a start of a packet. The SRC field indicates an address for a source. The DST field indicates an address for a target. The CMD field indicates an instruction transferred from the source to the target. The LEN field indicates a length of the data field or data. The data field includes data associated with an instruction. The EXT field indicates an end of the packet. The CS field is used to check an error of the packet.

The CMD field may include at least one of a target reset instruction, an input voltage/current request instruction, an output voltage/current request instruction, a target state request instruction, a target charging control instruction, an access standard instruction, a control ID assignment instruction, a target SCB information request instruction, and a channel change request instruction.

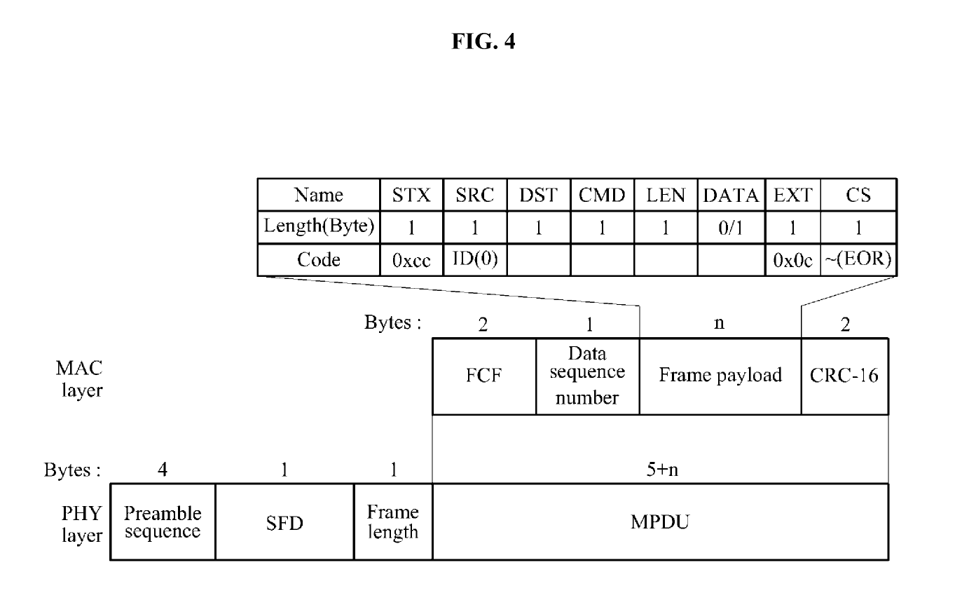

FIG. 4 illustrates an example of a format of a frame transmitted by the communication apparatus in the wireless power transmission system.

A source and a target exchanges a wireless power transmission frame with each other. The wireless power transmission frame includes the format shown in FIG. 4. Referring to FIG. 4, the wireless power transmission frame is divided into a PHY layer and a MAC layer.

As illustrated in FIG. 4, the PHY layer includes a preamble sequence field, a start of frame delimiter (SFD) field, a frame length field, and a MAC protocol data unit (MPDU) field.

The preamble sequence field is used to acquire symbol synchronization or chip synchronization associated with a new frame, and may be used to synchronize a source and a target in the PHY layer. The SFD field indicates a start of a new frame. The frame length field defines a number of all octets included in a MPDU. The MPDU field may indicate MAC information, and may be used to transfer a frame to the MAC layer.

As illustrated in FIG. 4, the MAC layer includes a frame control field (FCF), a data sequence number (DSN) field, a frame payload field, and a cycle redundancy check (CRC)-16 field.

The FCF indicates properties of a frame. The properties of the frame may include, for example, a beacon, a notification, a MAC instruction, and other similar types of properties. The DSN field indicates a unique sequence ID of a transmitted frame. The frame payload field indicates information regarding a frame. The CRC-16 field includes a 16-bit CRC code and may be used to verify an error of a frame using a 16^{th}-order polynomial.

The frame payload field of the MAC layer may include an STX field, an SRC field, a DST field, a CMD field, a LEN field, a data field, an ETX field, and a CS field.

The STX field indicates a start of a packet. The SRC field indicates an address for a source. The DST field indicates an address for a target. The CMD field indicates an instruction transferred from the source to the target. The LEN field indicates a length of the data field or data. The data field includes data associated with an instruction. The EXT field indicates an end of a packet. The CS field is used to check an error of a packet. For example, 1 byte is assigned to each of the fields other than the data field. Additionally, a code is assigned based on information included in each of the fields. For example, ‘Oxcc’ is used as a code to notify a start of a packet.

The CMD field includes at least one of a target reset instruction, an input voltage/current request instruction, an output voltage/current request instruction, a target state request instruction, a target charging control instruction, an access standard instruction, a control ID assignment instruction, a target SCB information request instruction, and a channel change request instruction.

In one example, the access standard instruction includes information as shown in Table 5.

TABLE 5

| Position | D7 | D6, D5 | D4, D3, D2, D1, D0 |
|---|---|---|---|
| Length | 1 bit | 2 bits | 5 bits |
| Category | M/L | Search bit | Movement argument |
| Initial value | 0 | 2 | 0 |
| Effective value | 0~1 | 0~3 | 0~31 |

In Table 5, the position indicates where a reference point is located in one of 8 bits of 1 byte. For example, D7 may indicate an eighth bit used as a reference point. The reference point may be set to a most significant bit (MSB) or a least significant bit (LSB) among all bits. Because the MSB or the LSB is used as a reference point, 1 bit may be assigned to D7. For example, ‘0’ may indicate an MSB, and ‘1’ may indicate an LSB.

D6 and D5 indicate a seventh bit and a sixth bit, respectively, which are used as call arguments. The call argument refers to a number of search bits that need to be searched for based on the reference point and to identify temporary IDs of targets. For example, two bits may be assigned to each of D6 and D5. In this example, one to four search bits are used as call arguments.

D0 to D4 indicate a first bit to a fifth bit, respectively, which are used as movement arguments. The movement argument refers to a number of bits of a search start position moved when identifying temporary IDs of targets using a set call argument fails. Because five bits are assigned to each of D0 to D4, 1 to 32 search bits may be moved.

The source transmits a packet including a frame payload. The packet from the source may include an STX field, an SRC field, a DST field, a CMD field, a LEN field, a data field, an ETX field, and a CS field, as shown in Table 6.

TABLE 6

| Name | STX | SRC | DST | CMD | LEN | DATA | ETX | CS |
|---|---|---|---|---|---|---|---|---|
| Length | 1 | 1 | 1 | 1 | 1 | n | 1 | 1 |
| Code | 0 × CC | ID[0] | | | | | 0 × 0C | ~(XOR) |

For example, in the STX field, ‘0xCC’ is used as a code. In the SRC field, an LSB of an ID of a source is used as a code. In the access mode, a call parameter is assigned as a code to the DST field, and in the charging mode, a control ID is assigned as a code to the DST field. In the CMD field, a code with ‘0’ of an upper nibble is used. In the LEN field, a length of data is represented as a code. The data field indicates a data stream, and a length of the data field is determined based on a type of instructions. In the ETX field, ‘0x0C’ is used as a code. The CS field indicates an error verification scheme, for example, a scheme to perform a complementary eXclusive OR (XOR) operation to bits assigned to the STX field through the ETX field.

A packet of a target may include an STX field, an SRC field, a DST field, a CMD field, a LEN field, a data field, an ETX field, and a CS field, as shown in Table 7.

TABLE 7

| Name | STX | SRC | DST | CMD | LEN | DATA | ETX | CS |
|---|---|---|---|---|---|---|---|---|
| Length | 1 | 1 | 1 | 1 | 1 | N | 1 | 1 |
| Code | 0 × CC | ID[0] | | | | | 0 × 0C | ~(XOR) |

For example, in the STX field, ‘0xCC’ may be used as a code. In the SRC field, an LSB of an ID of a target may be used as a code. In the DST field, an ID of a source may be assigned as a code. In the CMD field, a code with ‘1’ of an upper nibble is used. In the LEN field, a length of data may be represented as a code. The data field indicates a data stream, and a length of the data field is determined based on a type of instructions. In the ETX field, ‘0x0C’ is used as a code. The CS field indicates an error verification scheme, for example, a scheme to perform a complementary eXclusive OR (XOR) operation to bits assigned to the STX field through the ETX field.

Rules of Transmission and Reception of Packet

A packet transmitted from a source to a target may be defined to be a request packet. Additionally, a packet transmitted from the target to the source may be defined to be a response packet.

A DST field of a request packet of the source may include information regarding three examples. In a first example, when a broadcasting instruction is transmitted, a value of ‘0xFF’ is assigned. In a second example, in the access mode, a call parameter is assigned. The call parameter is represented, for example, as ‘0x00,’ ‘0x01,’ ‘0x02,’ and other similar representations. In a third example, in the charging mode, a control ID of the target is assigned. The control ID is represented, for example, as ‘0x01,’ ‘0x02,’ ‘0x0n,’ and other similar representations.

In an example where the broadcasting instruction is assigned to the DST field of the request packet, the target does not respond. In another example in which the call parameter or the control ID is assigned to the DST field of the request packet, the target transmits a response packet, such as, an acknowledgment (ACK).

Each of a target reset instruction and a channel change request instruction are set as a broadcasting instruction, or as an individual instruction to which a control ID is assigned.

The target is not used a negative acknowledgement (NAK) signal.

In a case that an instruction requiring a response of the target is transmitted, when the target does not respond or when a checksum error occurs, the source may re-transmit the instruction.

2. Examples of instructions included in request packet transmitted from source to target are illustrated in Table 8.

TABLE 8

| Name | STX | SRC | DST | CMD | LEN | DATA | ETX | CS | |
|---|---|---|---|---|---|---|---|---|---|
| Length (byte) | 1 | 1 | 1 | 1 | 1 | 0/1 | 1 | 1 | Request |
| Code | 0 × cc | ID(0) | | | | | 0 × 0c | ~(XOR) | interval |
| Instruction list | | | | | | | | | |
| Target reset | | | ff, 1~n | 0 × 01 | 0 | none | | | Irregular |
| Input | | | n | 0 × 02 | 0 | none | | | 1~60 |
| voltage/current | | | | | | | | | seconds |
| request | | | | | | | | | |
| Output | | | n | 0 × 03 | 0 | none | | | 1~60 |
| voltage/current | | | | | | | | | seconds |
| request | | | | | | | | | |
| Target state | | | n | 0 × 04 | 0 | none | | | 1~60 |
| request | | | | | | | | | seconds |
| Target | | | n | 0 × 05 | 1 | 0 × 01/00 | | | Irregular |
| charging control | | | | | | | | | |
| Access standard | | | 0~3 | 0 × 06 | 1 | | | | Irregular |
| Control ID | | | 0~3 | 0 × 07 | 1 | 0 × 01~03 | | | One time |
| assignment/ | | | | | | | | | immediately |
| response request | | | | | | | | | after access |
| Target SCB | | | n | 0 × 08 | 1 | | | | One time |
| request | | | | | | | | | immediately |
| | | | | | | | | | after access |
| Channel change | | | ff, 1~3 | 0 × 09 | 1 | Ch11~26 | | | Irregular |
| request | | | | | | | | | |

For example, when the target reset instruction is received at a target, the target determines whether to transmit a response packet and reset based on a type of a DST field of the received instruction. The type of the DST field includes three types of fields corresponding to a case in which a broadcasting instruction is transmitted, a case in which a call parameter is transmitted, and a case in which a control ID is assigned.

When voltage and/or current output from a target is maintained at a level below a predetermined level for a predetermined period of time, compared to voltage and/or current input to the target or when a temperature of the target increases beyond an optimal temperature, the source determines that abnormality occurs in the target and transmits the target reset instruction to the target.

The access standard instruction, the target reset instruction, and the channel change request instruction are set to a broadcasting instruction, or an individual instruction.

A built-in analog-to-digital converter (ADC) or an external ADC converts a voltage value and/or current value detected from an input terminal or output terminal of a target. A transmission length is determined based on a resolution of a used ADC. In an example of 12 bits, a target transmits four bytes in a unit of two bytes. In an example of 8 bits, response data include ‘ADC_0,’ and ‘ADC_1.’ ‘ADC0_High,’ ‘ADC0_Low,’ ‘ADC1_High,’ and ‘ADC1_Low’ may be sequentially set as response data exceeding 8 bits.

A voltage value and/or current value are determined to be detected from the input terminal or the output terminal, depending on a demand in the wireless power transmission system.

The target detects an abnormality and transmits to the source a bit set based on a type of the abnormality. For example, the abnormality of the target may include abnormality of a temperature in the target, abnormality of charging power, and other similar types of abnormal conditions.

The target charging control instruction are used to process a predetermined port of the target to be high or low. For example, ‘charging on’ may be indicated by ‘0x01’ and ‘charging off’ may be indicated by ‘0x00.’

The access standard instruction includes an access for a source to assign a control ID to a predetermined target, and may include information regarding a call argument, a movement argument, and other similar types of arguments.

Control IDs 1 to n may be assigned to targets, in an order that the targets access a source. For example, n is determined based on a maximum number of targets accessible to the source.

When a target to which a control ID is assigned does not respond to a request packet of a source ‘M’ times, the source cancels assignment of the control ID. In this example, ‘M’ is set for each product or set based on a situation of a wireless power field.

The source transmits a target SCB information request instruction to request information in an SCB of the target. Based on a response packet, the source verifies requirements to charge the target and to transmit power and data to the target.

When a currently used communication channel is in an abnormal state, the source searches for a new channel, and requests the target to change the currently used communication channel to the new channel. In this example, the abnormal state of the communication channel includes, a state in which the target does not respond to a request instruction of the source or a state in which an error occurs in a response packet received from the target.

An ACK may function as a response signal of the target in response to a request from the source. The ACK may be only used by the target. In one example, the target would not be using a NAK.

When the target does not respond to a request instruction received from the source, or when a checksum is not matched, the source may re-transmit the request instruction ‘K’ times. In this example, ‘K’ is set for each product or is set based on a situation of a wireless power field.

3. Examples of instructions included in response packet transmitted from a target to a source are illustrated in Table 9.

Instructions transmitted from the target to the source may have the same basic structure as instructions transmitted from the source to the target; however, there is a difference in upper nibble of a CMD field.

TABLE 9

| Name | STX | SRC | DST | CMD | LEN | DATA | | ETX | CS |
|---|---|---|---|---|---|---|---|---|---|
| Length (byte) | 1 | 1 | 1 | 1 | 1 | 0/1 | | 1 | 1 |
| Code | 0 × cc | ID(0) | | | | | | 0 × 0c | ~(XOR) |
| Target reset | | | ff, 1~n | 0 × 11 | 0 | none | | | |
| Input | | | 1~n | 0 × 12 | 2/4 | 2/4 | byte | | |
| voltage/current request | | | | | | | | | |
| Output | | | 1~n | 0 × 13 | 2/4 | 2/4 | byte | | |
| voltage/current request | | | | | | | | | |
| Target state request | | | 1~n | 0 × 14 | 1 | 1 | byte | | |
| Target charging control | | | 1~n | 0 × 15 | 0 | none | | | |
| Access standard | | | 0~n | 0 × 16 | 0 | none | | | |
| Control ID | | | 0~n | 0 × 17 | 0 | none | | | |
| assignment/response | | | | | | | | | |
| request | | | | | | | | | |
| Target SCB request | | | 1~n | 0 × 18 | 8 | 8 | byte | | |

| | | | | |
|---|---|---|---|---|
| Channel change request | ff, 1~n | 0 × 19 | 0 | none |

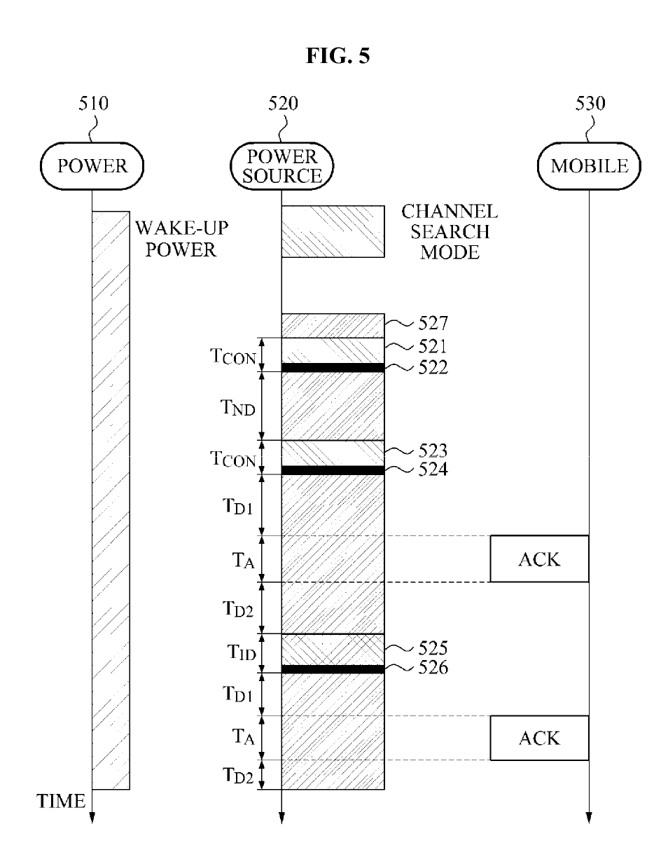

FIG. 5 illustrates an example of an access mode between a source and a single target in the wireless power transmission system.

Referring to FIG. 5, the wireless power transmission system includes a power source 520 and a mobile 530. The mobile 530 may correspond to a target.

The power source 520 may remain in the standby mode until a start button is actuated. When a charging start command is received, the power source 520 transmits a wake-up power to a wireless power transmission region. The charging start command is input by actuation of the start button, or input immediately when the mobile 530 is detected in the wireless power transmission region.

The power source 520 communicates with the mobile 530, while transmitting wireless power 510. In the access mode, the power source 520 transmits a predetermined amount of wake-up power. The wake-up power refers to a minimum amount of power required by the mobile 530 to perform communication.

In response to the charging start command, the power source 520 searches for a communicable channel in a channel search mode. The power source 520 measures a level of an interfering signal for each channel, and determines a channel in which a level of an the interfering signal is equal to or less than a reference level as a communication channel.

When the communication channel is determined, the power source 520 transmits a channel seizure signal 527 using a communication frequency of the communication channel. The channel seizure signal 527 may be, for example, a CW signal. The channel seizure signal 527 is easily identified by another source or another target because a bandwidth of the channel seizure signal 527 is narrower than a typical communication signal, and power of the channel seizure signal 527 is higher than the typical communication signal. Additionally, another source or another target may determine that a channel to receive the channel seizure signal 527 is being used by the power source 520.

During a time T_{CON}, the power source 520 transmits an access standard instruction 521 and a state information signal 522. The access standard instruction 521 includes a reference used to assign control IDs to identify the mobile 530 from other targets. For example, a reference point, a call argument, and a movement argument may be used as a reference. When the reference is satisfied, the mobile 530 transmits an ACK. The state information signal 522 includes information indicating that the power source 520 currently transmits the access standard instruction 521 and is being operated in the access mode. The state information signal 522 may be stored in a part of a packet.

During a time T_{ND}, the power source 520 waits until a response signal corresponding to the access standard instruction 521 is received. The time T_{ND} refers to a maximum waiting time set to receive the response signal. During the time T_{ND}, the power source 520 transmits a CW signal and notifies neighboring devices that the communication channel is being occupied.

During a time T_{CON} after the time T_{ND}, the power source 520 transmits an access standard instruction 523 and a state information signal 524.

During a time T_{D1}, the power source 520 waits until a response signal corresponding to the access standard instruction 523 is received. The time T_{D1} refers to a waiting time required to receive the response signal. During a time T_{A}, the power source 520 receives the response signal from the mobile 530. During a time T_{D2}, the power source 520 determines a control ID based on the received response signal. During the times T_{D1}, T_{A}, and T_{D2}, the power source 520 transmits a CW signal.

During a time T_{ID}, the power source 520 transmits a control ID assignment instruction 525 and a state information signal 526. The state information signal 526 includes information indicating that the power source 520 currently transmits the control ID assignment instruction 525 and is operated in the access mode. For example, when the state information signal 526 is received, neighboring sources and neighboring targets determine that the power source 520 is being operated in the access mode with the mobile 530. Neighboring sources and neighboring targets may also search for other channels.

During a time T_{D1}, the power source 520 waits until a response signal corresponding to the control ID assignment instruction 525 is received. During a time T_{A}, the power source 520 receives the response signal from the mobile 530. During a time T_{D2}, the power source 520 processes an internal operation based on the received response signal. During the times T_{D1}, T_{A}, and T_{D2}, the power source 520 transmits a CW signal.

When the control ID is assigned to the mobile 530, the power source 520 is operated in the charging mode.

The power source 520 requests information associated with the mobile 530 to transmit power required at the mobile 530. The information associated with the mobile 530 may include, for example, a model name of the mobile 530, charging information regarding a charging state of a battery of the mobile 530, and other similar type of information.

The power source 520 determines initial wireless power based on the charging state information. Additionally, the power source 520 determines initial wireless power based on the charging state information and information regarding an efficiency of a source resonator.

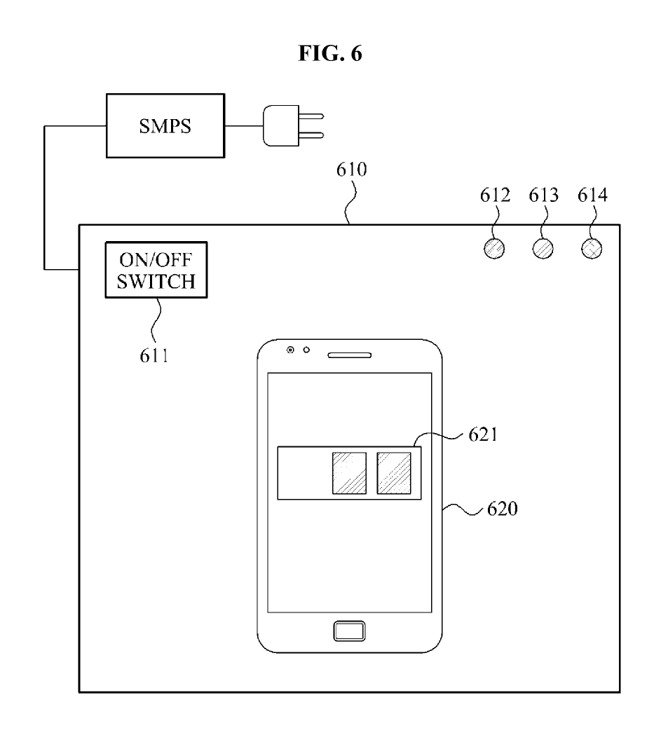

FIG. 6 is a diagram illustrating an example in which a load at a target has changed in the wireless power transmission system.

Referring to FIG. 6, a source 610 is implemented in the form of a pad. The source 610 may receive power supply from an SMPS via a cable.

An on/off switch 611 refers to a charging start button of a source. In an example in which the on/off switch 611 is turned on, the source 610 starts a charging process. In another example in which the on/off switch 611 is turned off, the source 610 terminates the charging process.

In FIG. 6, the source 610 includes light-emitting diode (LED) indicators 612, 613, and 614. Using a color, the LED indicator 612 indicates that the source 610 is being operated in the standby mode. Using another color, the LED indicator 613 indicates that the source 610 is operated in the access mode. Using still another color, the LED indicator 614 indicates that the source 610 is being operated in the charging mode. The LED indicator 614 can also display different colors to distinguish from a state in which the charging process is completed to a state in which the charging process is being performed.

For example, when the target 620 is located in a wireless power transmission region of the source 610, namely, located above the source 610, the charging process starts and power is transferred from the source 610 to the target 620. A battery charging state indicator 621 of the target 620 indicates that the source 610 is using power to charge the target 620. When a battery of the target 620 is charged, the load at the target 620 has changed. Due to a change in the load at the target 620, the source 610 enables the transmitted power to automatically vary through impedance matching.

The LED indicators 612 to 614 indicate whether initialization of the source 610 is normally performed, whether abnormality occurs in the source 610, whether the target 620 is being charged by the source 610, and whether a communication error occurs between the source 610 and the target 620. In one example, the LED indicators 612 to 614 display green, red, and yellow, respectively. In this example, when power is supplied to the source 610, the LED indicators 612 to 614 sequentially flicker. In an example, when hardware initialization of the source 610 is successfully performed, the LED indicator 612 emitting green is turned on. In another example, when the hardware initialization fails or when abnormality occurs while the source 610 is operated, the LED indicator 613 emitting red flickers. In still another example, when the source 610 is charging the target 620, the LED indicator 613 emitting red may be turned on. In yet another example, when the communication error between the source 610 and the target 620 occurs, the LED indicator 614 emitting yellow flickers. The above examples may show a relationship between a single target and three LED indicators.

In addition to the LED indicators 612 to 614, a set of LED indicators may be added based on a number of targets accessible to the source 610. For example, LED indicators may be disposed on the source 610 and may be turned on or flicker for each zone. In this example, based on positions of targets, the LED indicators may indicate states, such as a state in which initialization is completed, a state in which charging is being performed, a state in which a communication error occurs, and other similar types of states.

The target 620 includes a set of LED indicators, such as a first LED indicator, a second LED indicator, and a third LED indicator.

The first LED indicator may be turned on when hardware initialization is normally performed by supply of wake-up power to the target 620.

The second LED indicator may flicker when hardware initialization is not normally performed, or when abnormality occurs in an operation of the target 620. The second LED indicator may be turned on when the target 620 is being charged.

The third LED indicator may flicker when a communication error occurs between the source 610 and the target 620.

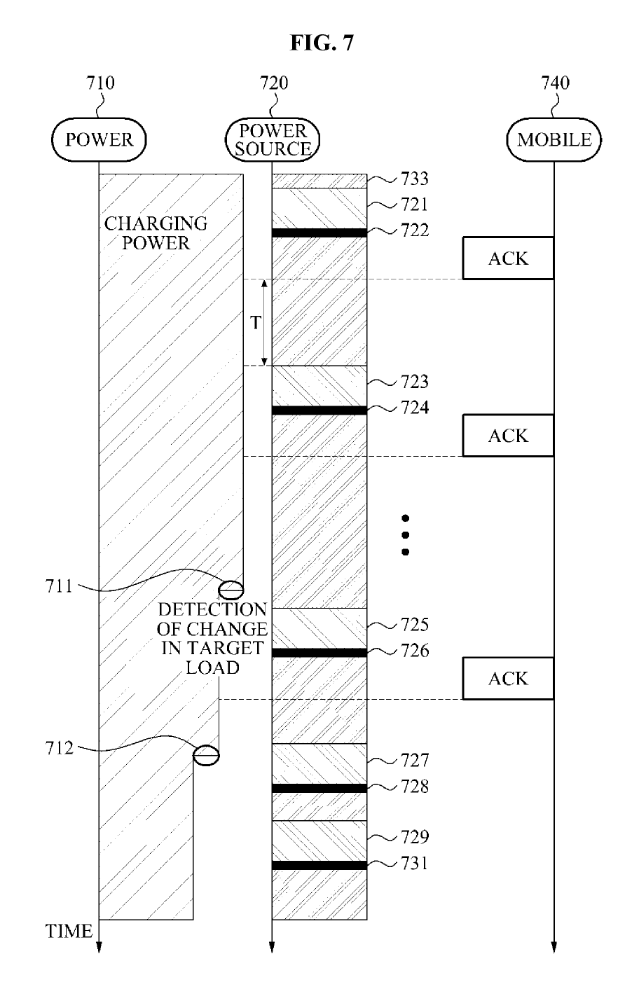

FIG. 7 is a diagram illustrating an example of an operation performed at the source when the load at the target changes in a charging mode in the wireless power transmission system.

Referring to FIG. 7, the wireless power transmission system includes a power source 720 and a mobile 740. The mobile 740 may correspond to the target.

The power source 720 transmits initial wireless power to the mobile 740. In FIG. 7, power 710 transmitted from the power source 720 is used as charging power. A block indicated by the charging power may correspond to an amount of charging power.

The power source 720 continues to transmit a channel seizure signal 733 indicating that a communication channel is being occupied. Using a communication frequency of the communication channel, the power source 720 transmits a charging information request signal 721 and a state information signal 722.

The charging information request signal 721 is used to request charging information regarding a charging state of the mobile 740. For example, the charging information request signal 721 is transmitted to request a voltage value and/or current value from an output terminal of the mobile 740.

The state information signal 722 includes information indicating that the power source 720 currently transmits the charging information request signal 721 and is being operated in the charging mode. The state information signal 722 is stored in a part of a packet.

In response, the power source 720 receives an ACK from the mobile 740. The power source 720 receives the charging information from the mobile 740 and determines whether the load of the mobile 740 has changed.

When a predetermined time T elapses, the power source 720 transmits a charging information request signal 723 and a state information signal 724. In response, the power source 720 receives an ACK from the mobile 740.

The power source 720 transmits a charging information request signal in an interval of time T. Based on the charging information, when it is determined that the load of the mobile 740 has changed, the power source 720 adjusts power that is to be transmitted. For example, based on a charging state of a battery of the mobile 740, the power source 720 adjusts an amount of power to be transmitted. The battery is charged in either a constant current (CC) mode, or a constant voltage (CV) mode, based on a battery charge level.

Additionally, when the load of the mobile 740 has changed, the power source 720 may perform impedance matching using a matching network of the power source 720. As a result, power output from a power amplifier of the power source 720 may be changed. At 711, the power source 720 detects a change in the power output from the power amplifier, and detects a change in the load of the mobile 740.

When the change in the load of the mobile 740 is detected, the power source 720 transmits a charging information request signal 725 and a state information signal 726. In response, the power source 720 receives an ACK from the mobile 740. Additionally, the power source 720 receives the charging information from the mobile 740.

At 727, the power source 720 adjusts power that is to be transmitted based on the received charging information. Further, the power source 720 transmits a state information signal 728 notifying that the power to be transmitted is being adjusted. In one example, the power is adjusted by an amount corresponding to the change in the load in operation 712.

At 729, the power source 720 transmits the adjusted power. The power source 720 transmits a state information signal 731 notifying that the adjusted power is being transmitted.

Based on charging information, when the charging of the mobile 740 is determined to be completed, the power source 720 transmits a target charging control instruction and turns off a charging port of the mobile 740. For example, when the charging information request signal 725 is received and when charging of the battery is determined to be completed, the mobile 740 automatically turns off the charging port.

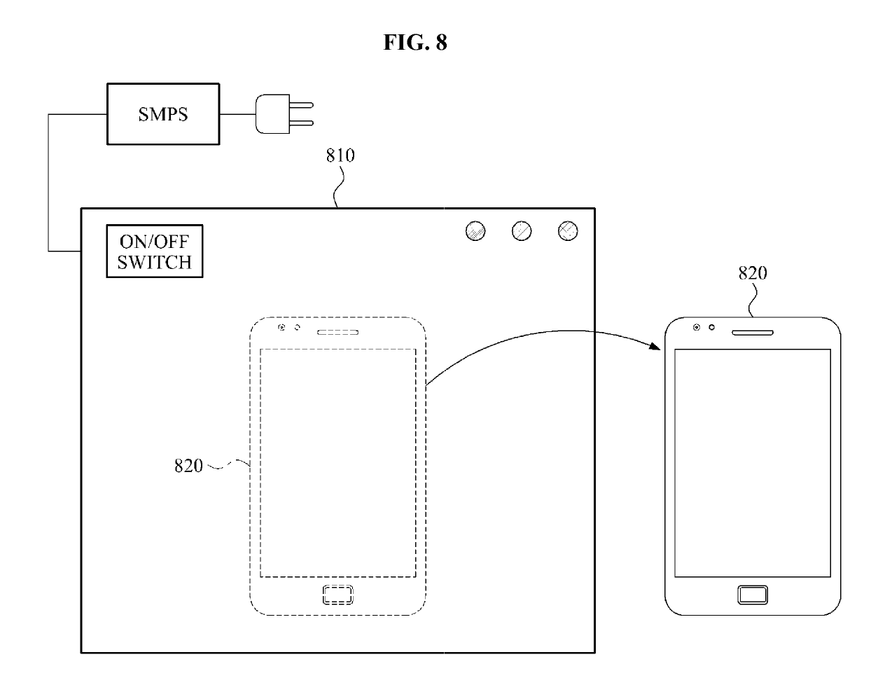

FIG. 8 is a diagram illustrating an example in which the target is removed while charging in the wireless power transmission system.

Referring to FIG. 8, a source 810 is implemented in the form of a pad. The source 810 receives a power supply from an SMPS via a cable.

For example, when a target 820 is located in a wireless power transmission region of the source 810, for example, located above the source 810, a charging process starts and power is transferred from the source 810 to the target 820. During the charging process, the target 820 may be removed from the source 810. For example, when the target 820 is spaced apart by a predetermined distance from the source 810, the target 820 may not receive the power from the source 810 anymore. In other words, when the target 820 is removed from the source 810, the source 810 may detect a removal of the target 820 and may terminate the charging process.

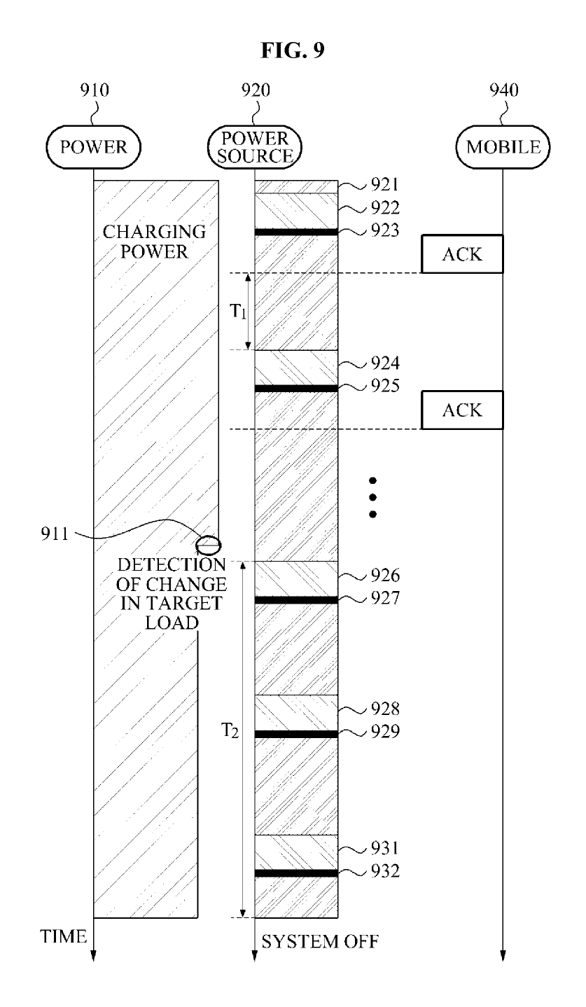

FIG. 9 is a diagram illustrating an example of an operation performed at the source when the target is removed while charging in the wireless power transmission system.

Referring to FIG. 9, the wireless power transmission system includes a power source 920 and a mobile 940. The mobile 940 may correspond to the target.

The power source 920 transmits wireless power to the mobile 940. In FIG. 9, power 910 transmitted from the power source 920 is used as charging power. A block indicated by the charging power may correspond to an amount of charging power.

The power source 920 continues to transmit a channel seizure signal 921 indicating that a communication channel is being occupied.

Using a communication frequency of the communication channel, the power source 920 transmits a charging information request signal 922 and a state information signal 923. The charging information request signal 922 is used to request charging information regarding a charging state of the mobile 940. For example, the charging information request signal 922 may be transmitted to request a voltage value and/or current value from an output terminal of the mobile 940. The state information signal 923 includes information indicating that the power source 920 currently transmits the charging information request signal 922 and is being operated in the charging mode. The state information signal 923 may be stored in a part of a packet.

In response, the power source 920 receives an ACK from the mobile 940. The power source 920 receives the charging information from the mobile 940, and determines whether the load of the mobile 940 has changed.

When a predetermined time T₁ elapses, the power source 920 may transmit a charging information request signal 924, and a state information signal 925. In response, the power source 920 may receive an ACK from the mobile 940.

The power source 920 may transmit a charging information request signal in an interval of time T₁. In an example, when a response signal corresponding to the charging information request signal is not received from the mobile 940 for a predetermined period of time, the power source 920 may determine that the mobile 940 disappears. In another example, when a control ID request signal, instead of the charging information request signal, is transmitted to the mobile 940, and when a response signal corresponding to the control ID request signal is not received from the mobile 940, the power source 920 may determine that the mobile 940 disappears.

The power source 920 may monitor power output from a power amplifier of the power source 920. In 911, when the output power changes, the power source 920 transmits a charging information request signal 926 and a state information signal 927. Subsequently, the power source 920 waits for a predetermined period of time until a response signal is received.

During a time T₂, the power source 920 transmits a charging information request signal 928 and a state information signal 929. The power source 920 also waits until response signals, which correspond to the charging information request signal 928 and the state information signal 929, are received. During a time T₂, the power source 920 further transmits a charging information request signal 931 and a state information signal 932. The power source 920 waits until response signals, which correspond to the charging information request signal 931 and the state information signal 932, are received. When a response signal is not received from the mobile 940 during the time T₂, the power source 920 determines that the mobile 940 is not located in a wireless power transmission region of the power source 920. In other words, the power source 920 determines that the mobile 940 has disappeared.

When the mobile 940 is determined to have disappeared, the power source 920 terminates the charging process. The power source 920 may turn off the wireless power transmission system, and may terminate the charging process. For example, the power source 920 determines that the mobile 940 disappears using an external sensor and terminates the charging process.

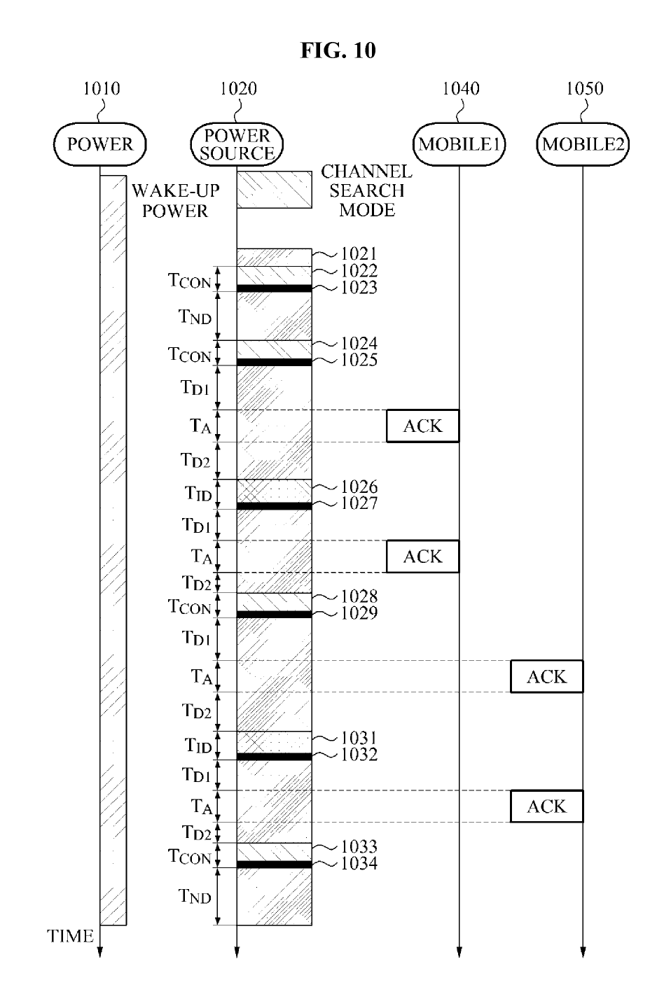

FIG. 10 is a diagram illustrating an example of an access mode between the source and a plurality of targets in the wireless power transmission system.

Referring to FIG. 10, the wireless power transmission system includes a power source 1020, a first mobile (i.e., mobile1) 1040, and a second mobile (i.e., mobile2) 1050. The first mobile 1040 and the second mobile 1050 correspond to a plurality of targets.

The power source 1020 remains in the standby mode until a start button is actuated. When a charging start command is received, the power source 1020 transmits a wake-up power to a wireless power transmission region. The charging start command is input by actuating the start button, or is input immediately when the first mobile 1040 is detected in the wireless power transmission region.

The power source 1020 communicates with the first mobile 1040 while transmitting wireless power 1010. In the access mode, the power source 1020 transmits a predetermined amount of wake-up power. The wake-up power refers to a minimum amount of power required by the first mobile 1040 to perform communication.

In response to the charging start command, the power source 1020 searches for a communicable channel in a channel search mode. The power source 1020 measures a level of an interfering signal for each channel, and determines, as a communication channel, a channel in which a level of an interfering signal is equal to or less than a reference level.

When the communication channel is determined, the power source 1020 transmits a channel seizure signal 1021 using a communication frequency of the communication channel. The channel seizure signal 1021 may be, for example, a CW signal. The channel seizure signal 1021 may be easily identified by another source or another target because a bandwidth of the channel seizure signal 1021 is narrower than a typical communication signal, and power of the channel seizure signal 1021 is higher than the typical communication signal. Additionally, another source or another target may determine that a channel to receive the channel seizure signal 1021 is being used by the power source 1020.

During a time T_{CON}, the power source 1020 transmits an access standard instruction 1022 and a state information signal 1023. The access standard instruction 1022 includes a reference used to assign control IDs to identify the first mobile 1040 from the other targets. For example, a reference point, a call argument, and a movement argument may be used as a reference. When the reference is satisfied, the first mobile 1040 transmits an ACK. The state information signal 1023 includes information indicating that the power source 1020 currently transmits the access standard instruction 1022 and is being operated in the access mode. The state information signal 1023 is stored in a portion of a packet.

During a time T_{ND}, the power source 1020 waits until a response signal corresponding to the access standard instruction 1022 is received. The time T_{ND} refers to a maximum waiting time set to receive the response signal. During the time T_{ND}, the power source 1020 transmits a CW signal, and notifies neighboring devices that the communication channel is being occupied.

During a time T_{CON} and after the time T_{ND}, the power source 1020 transmits an access standard instruction 1024 and a state information signal 1025.

During a time T_{D1}, the power source 1020 waits until a response signal corresponding to the access standard instruction 1024 is received. The time T_{D1} refers to a waiting time required to receive the response signal. During a time T_{A}, the power source 1020 receives the response signal from the first mobile 1040. During a time T_{D2}, the power source 1020 determines a control ID based on the received response signal. During the times T_{D1}, T_{A}, and T_{D2}, the power source 1020 may transmit a CW signal.

During a time T_{ID}, the power source 1020 transmits a control ID assignment instruction 1026 and a state information signal 1027. The state information signal 1027 includes information indicating that the power source 1020 currently transmits the control ID assignment instruction 1026 and is operating in the access mode. For example, when the state information signal 1027 is received, neighboring sources determine that the power source 1020 is operating in the access mode with the first mobile 1040. As a result, the neighboring sources may search for other channels.

During a time T_{D1}, the power source 1020 waits until a response signal corresponding to the control ID assignment instruction 1026 is received. During a time T_{A}, the power source 1020 receives the response signal from the first mobile 1040. During a time T_{D2}, the power source 1020 processes an internal operation based on the received response signal. During the times T_{D1}, T_{A}, and T_{D2}, the power source 1020 may transmit a CW signal.

During a time T_{CON}, after the time T_{D2}, the power source 1020 transmits an access standard instruction 1028 and a state information signal 1029. The power source 1020 may transmit the access standard instruction 1028 to determine whether a target, other than the first mobile 1014, exists. The access standard instruction 1028 includes a reference used to assign control IDs to identify the second mobile 1050 from the other targets. For example, a reference point, a call argument, and a movement argument may be used as a reference. When the reference is satisfied, the second mobile 1050 transmits an ACK.

During a time T_{D1}, the power source 1020 waits until a response signal corresponding to the access standard instruction 1028 is received. The time T_{D1} refers to a waiting time required to receive the response signal. During a time T_{A}, the power source 1020 receives the response signal from the second mobile 1050. During a time T_{D2}, the power source 1020 determines a control ID based on the received response signal. During the times T_{D1}, T_{A}, and T_{D2}, the power source 1020 may transmit a CW signal.

During a time T_{ID}, the power source 1020 transmits a control ID assignment instruction 1031 and a state information signal 1032. The state information signal 1032 includes information indicating that the power source 1020 currently transmits the control ID assignment instruction 1031 and is being operated in the access mode. For example, when the state information signal 1032 is received, neighboring sources determine that the power source 1020 is being operated in the access mode with the second mobile 1050. As a result, the neighboring sources may search for other channels.

During a time T_{D1}, the power source 1020 waits until a response signal corresponding to the control ID assignment instruction 1031 is received. During a time T_{A}, the power source 1020 receives the response signal from the second mobile 1050. During a time T_{D2}, the power source 1020 processes an internal operation based on the received response signal. During the times T_{D1}, T_{A}, and T_{D2}, the power source 1020 transmits a CW signal. The first mobile 1040 and the second mobile 1050, to which the control IDs are assigned, as described above, may be recognized as targets to be charged in the power source 1020.

Subsequently, during a time T_{CON}, the power source 1020 transmits an access standard instruction 1033 and a state information signal 1034. For example, when a response signal is not received, even if the access standard instruction is transmitted a predetermined number of times for a predetermined period of time, the power source 1020 determines that there is no target. When the control IDs are assigned to the first mobile 1040 and the second mobile 1050, the power source 1020 is operated in the charging mode.

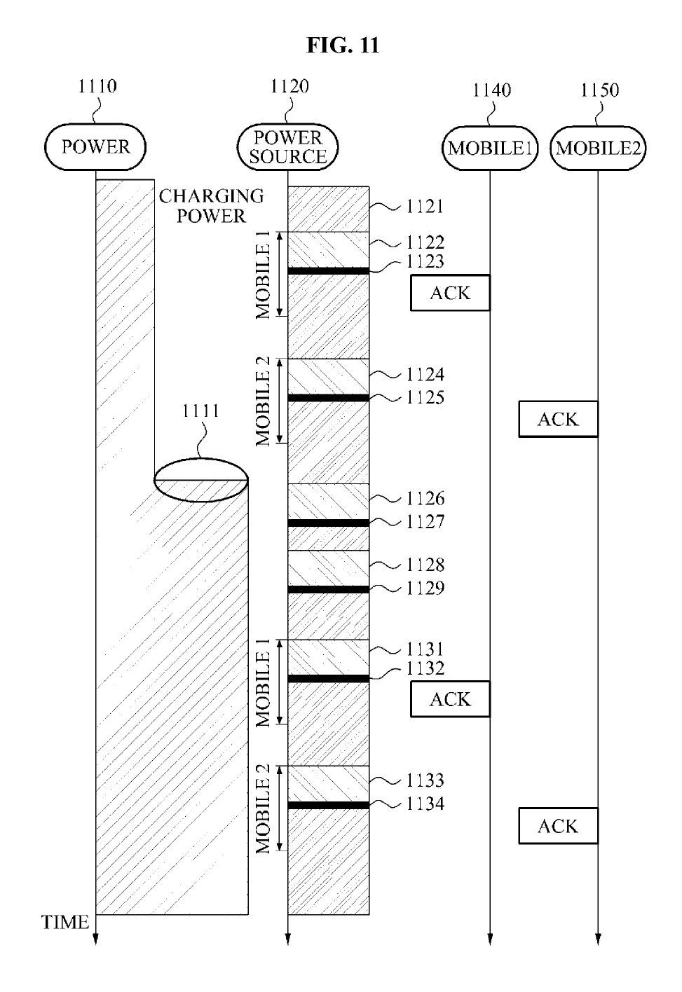

FIG. 11 is a diagram illustrating an example in which the source verifies the plurality of targets and sets supplied power in the wireless power transmission system.

Referring to FIG. 11, the wireless power transmission system includes a power source 1120, a first mobile 1140, and a second mobile 1150. The first mobile 1140 and the second mobile 1150 may correspond to a plurality of targets.

The power source 1120 transmits initial wireless power to the first mobile 1140 and the second mobile 1150. The initial wireless power may be determined based on information of a battery, for instance, battery capacity, of the first mobile 1140 and information of a battery of the second mobile 1150.

In FIG. 11, power 1110 is transmitted from the power source 1120 and may be used as charging power. A shaded block in FIG. 11 indicated by the charging power corresponds to an amount of charging power.

The power source 1120 continues by transmitting a channel seizure signal 1121 indicating that a communication channel is being occupied. The power source 1120 transmits a charging information request signal 1122 and a state information signal 1123 using a communication frequency of the communication channel.

The charging information request signal 1122 is used to request charging information regarding a charging state of the first mobile 1140. For example, the charging information request signal 1122 is transmitted to request a voltage value and/or current value of an output terminal of the first mobile 1140.

The state information signal 1123 includes information indicating that the power source 1120 currently transmits the charging information request signal 1122 and is being operated in the charging mode. The state information signal 1123 may be stored in a portion of a packet.

In response, the power source 1120 receives an ACK from the first mobile 1140. The power source 1120 receives the charging information from the first mobile 1140 and verifies a charging state of the battery of the first mobile 1140.

Using the communication frequency of the communication channel, the power source 1120 transmits a charging information request signal 1124 and a state information signal 1125.

The charging information request signal 1124 is used to request charging information regarding a charging state of the second mobile 1150. For example, the charging information request signal 1124 is transmitted to request a voltage value and/or current value from an output terminal of the second mobile 1150.

In response, the power source 1120 receives an ACK from the second mobile 1150. The power source 1120 receives the charging information from the second mobile 1150, and verifies a charging state of the battery of the second mobile 1150.

The power source 1120 adjusts power to be transmitted based on the charging state of the battery of the first mobile 1140. The power source 1120 also adjusts power to be transmitted based on the charging state of the battery of the second mobile 1150 in operation 1126. The power source 1120 transmits a state information signal 1127 notifying that the power to be transmitted is being adjusted. The power may be adjusted by an amount 1111 of power that is obtained by adding an amount of power required by the battery of the first mobile 1140 and an amount of power required by the battery of the second mobile 1150.

The power source 1120 transmits the adjusted power to the first mobile 1140 and the second mobile 1150 in operation 1128. The power source 1120 transmits a state information signal 1129 notifying that the adjusted power is being transmitted.

The power source 1120 transmits the power until the battery of the first mobile 1140 and the battery of the second mobile 1150 are completely charged.

The power source 1120 transmits to the first mobile 1140 a charging information request signal 1131 and a state information signal 1132. In response, the power source 1120 receives an ACK from the first mobile 1140. The power source 1120 also receives the charging information from the first mobile 1140 and determines whether the battery of the first mobile 1140 is completely charged.

The power source 1120 transmits to the second mobile 1150 a charging information request signal 1133, and state information signal 1134. In response, the power source 1120 receives an ACK from the second mobile 1150. The power source 1120 receives the charging information from the second mobile 1150. Also, the power source 1120 determines whether the battery of the second mobile 1150 is completely charged.

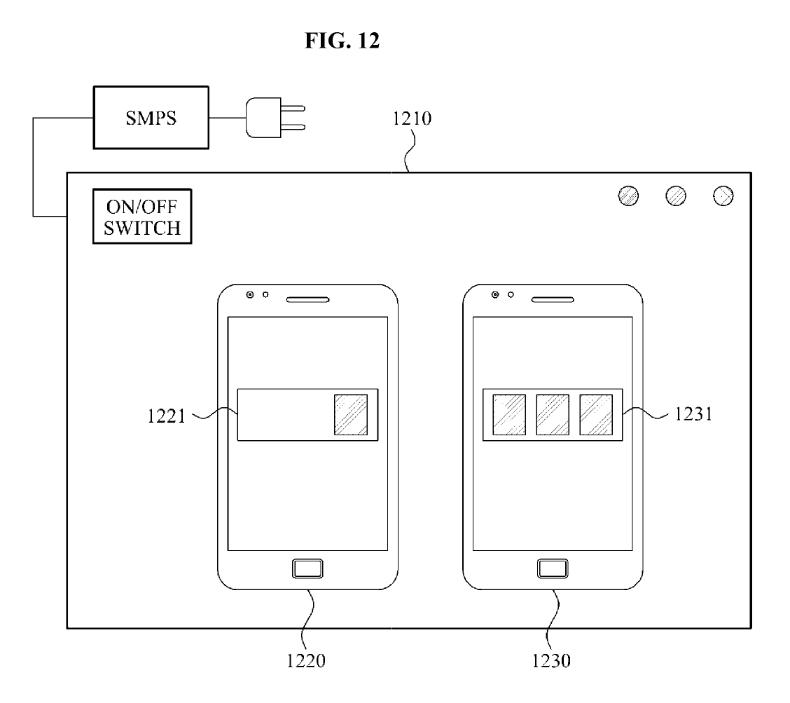

FIG. 12 is a diagram illustrating an example in which charging of one of the plurality of targets is completed in the wireless power transmission system.

Referring to FIG. 12, a source 1210 is implemented in the form of a pad. The source 1210 receives power supply from an SMPS via a cable.

Targets 1220 and 1230 of FIG. 12 receive wireless power from the source 1210. A battery charging state indicator 1221 of the target 1220 indicates that charging is not complete. A battery charging state indicator 1231 of the target 1230 indicates that charging is completed. Because a battery of the target 1230 is completely charged, the target 1230 may not need to be charged. As a result, the source 1210 determines that charging of the target 1230 is completed, and transmits a signal to control a charging port to prevent the target 1230 from being charged.

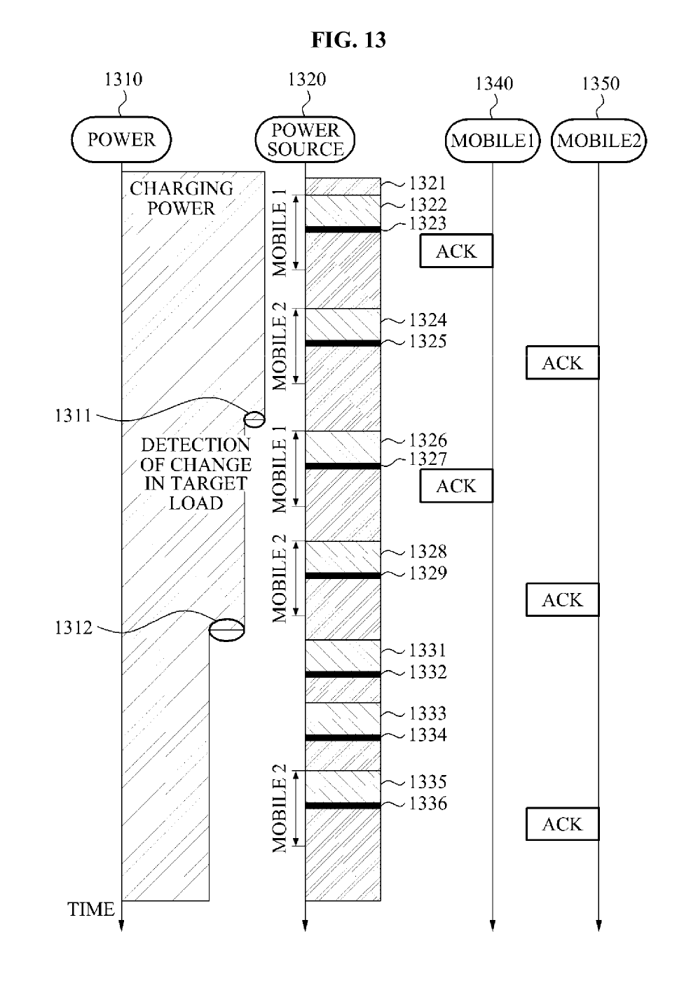

FIG. 13 is a diagram illustrating an example of operations of the source and the plurality of targets while charging one of the targets is completed in the wireless power transmission system.

Referring to FIG. 13, the wireless power transmission system includes a power source 1320, a first mobile (i.e., mobile1) 1340, and a second mobile (i.e., mobile2) 1350. The first mobile 1340 and the second mobile 1350 may correspond to a plurality of targets.

The power source 1320 transmits wireless power to the first mobile 1340 and the second mobile 1350. The wireless power may be determined based on a charging state of a battery of the first mobile 1340 and a charging state of a battery of the second mobile 1350. In FIG. 13, power 1310 transmitted from the power source 1320 is represented as charging power. A shaded block in FIG. 13 labeled as the charging power corresponds to an amount of charging power. The power source 1320 continues to transmit a channel seizure signal 1321 indicating that a communication channel is being occupied. Using a communication frequency of the communication channel, the power source 1320 transmits to the first mobile 1340 a charging information request signal 1322 and a state information signal 1323. Because a control ID of the first mobile 1340 is already known, the power source 1320 may easily transmit a signal.

The charging information request signal 1322 is used to request charging information regarding a charging state of the first mobile 1340. For example, the charging information request signal 1322 is transmitted to request a voltage value and/or current value of an output terminal of the first mobile 1340.

The state information signal 1323 includes information indicating that the power source 1320 currently transmits the charging information request signal 1322 and is being operated in the charging mode. The state information signal 1323 may be stored in a portion of a packet.

In response, the power source 1320 receives an ACK from the first mobile 1340. The power source 1320 receives the charging information from the first mobile 1340 and determines whether a load of the first mobile 1340 has changed.

Using the communication frequency of the communication channel, the power source 1320 transmits a charging information request signal 1324 and a state information signal 1325 to the second mobile 1350. In response, the power source 1320 receives an ACK from the second mobile 1350. The power source 1320 receives charging information regarding a charging state of the second mobile 1350 from the second mobile 1350. The power source 1320 also determines whether a load of the second mobile 1350 has changed.

The power source 1320 transmits a charging information request signal at regular intervals. Based on the charging information, when it is determined that the load of the first mobile 1340 or the load of the second mobile 1350 has changed, the power source 1320 adjusts power before it is transmitted. For example, the power source 1320 adjusts the power to be transmitted, based on the charging state of the battery of the first mobile 1340 and the charging state of the battery of the second mobile 1350. The batteries may be charged in either a CC mode or a CV mode, depending upon battery charge levels.

Additionally, when the load of the first mobile 1340 or the load of the second mobile 1350 has changed, impedance matching may be performed via a matching network of the power source 1320. As a result, power output from a power amplifier of the power source 1320 may be changed. At 1311, the power source 1320 detects a change in the power output from the power amplifier. The power source 1320 also detects a change in the load of the first mobile 1340 or the load of the second mobile 1350.

When the change in the load of the first mobile 1340 or the load of the second mobile 1350 is detected, the power source 1320 transmits to the first mobile 1340 a charging information request signal 1326 and a state information signal 1327. In response, the power source 1320 receives an ACK from the first mobile 1340. The power source 1320 receives the charging information from the first mobile 1340. The power source 1320 determines that the first mobile 1340 is completely charged based on the received charging information.

The power source 1320 transmits to the second mobile 1350 a charging information request signal 1328 and a state information signal 1329. In response, the power source 1320 receives an ACK from the second mobile 1350. The power source 1320 receives the charging information from the second mobile 1350.

At 1331, the power source 1320 adjusts power to be transmitted based on the first mobile 1340, which is completely charged, and second mobile 1350, currently being charged. The power source 1320 transmits a state information signal 1332 notifying that the power to be transmitted is being adjusted. The power may be adjusted by an amount of power 1312 required to completely charge the load of the second mobile 1350.

The power source 1320 transmits the adjusted power in operation 1333. The power source 1320 transmits the state information signal 1334 notifying that the adjusted power is being transmitted.

Based on the charging information, when the first mobile 1340 is determined to be completely charged, the power source 1320 transmits a target charging control instruction and turns off a charging port of the first mobile 1340. When the battery is determined to be completely charged and the charging information request signal 1326 is received, the first mobile 1340 may automatically turn off the charging port.

The power source 1320 transmits to the second mobile 1350, a charging information request signal 1335 and a state information signal 1336. In response, the power source 1320 receives an ACK from the second mobile 1350. The power source 1320 requests the charging information, until the second mobile 1350 is completely charged.

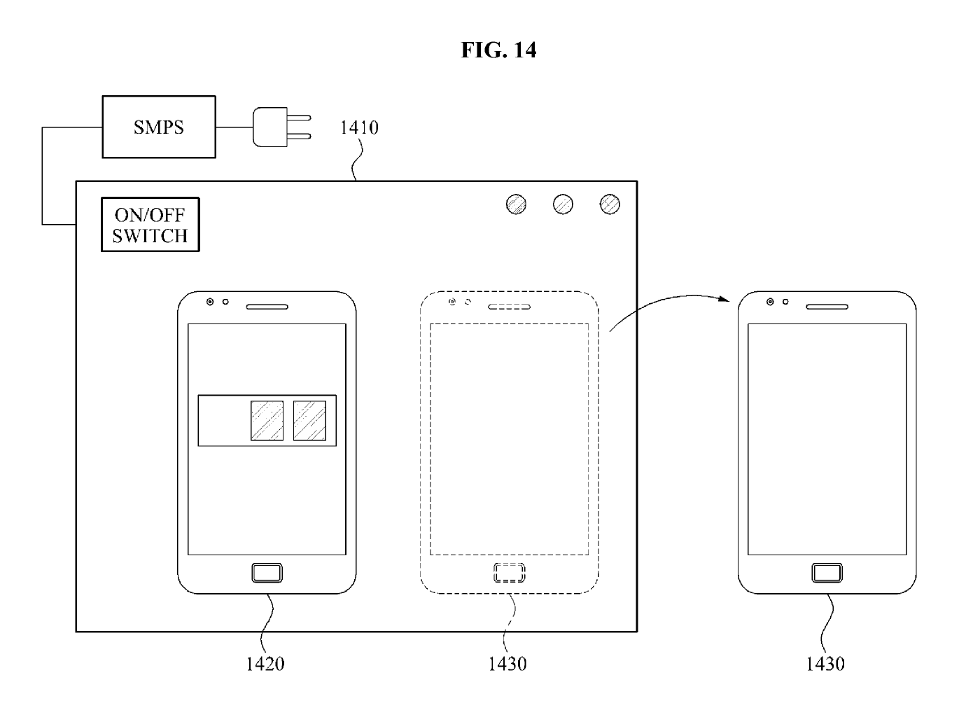

FIG. 14 is a diagram illustrating an example in which one of the plurality of targets is removed while the targets are charged in the wireless power transmission system.

Referring to FIG. 14, a source 1410 is implemented in the form of a pad. The source 1410 receives a power supply from an SMPS via a cable.

Targets 1420 and 1430 receive wireless power from the source 1410. The target 1430 disposed on the source 1410 may be moved. For example, when the target 1430 is moved as indicated by an arrow of FIG. 14, the source 1410 may transmit only power required to charge a battery of the target 1420. Accordingly, an amount of power to be transmitted may need to be adjusted. The source 1410 needs to detect movement of the target 1430.

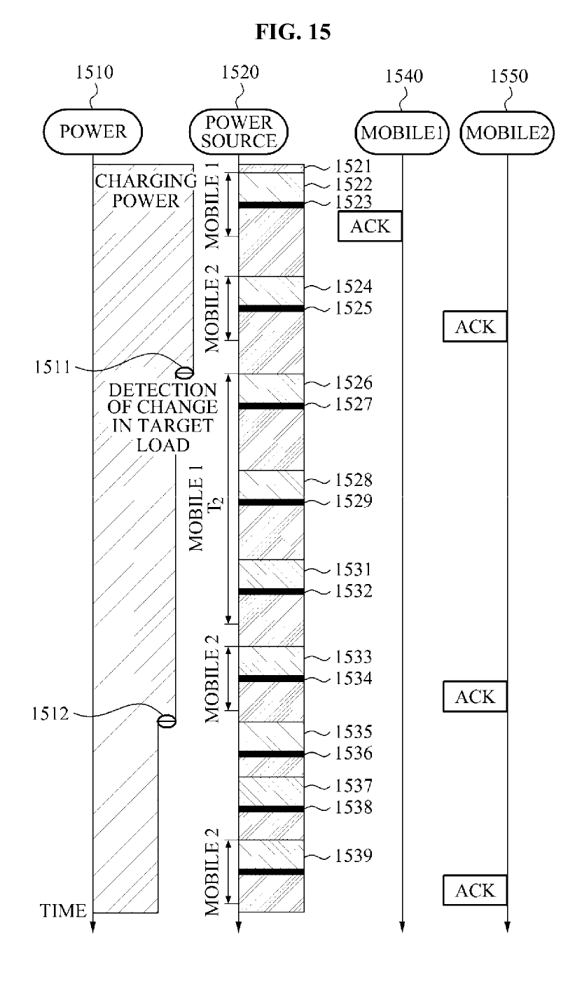

FIG. 15 is a diagram illustrating an example of operations between the source and the plurality of targets when one of the targets is removed while the targets are charged in the wireless power transmission system.

Referring to FIG. 15, the wireless power transmission system includes a power source 1520, a first mobile 1540, and a second mobile 1550. The first mobile 1540 and the second mobile 1550 may correspond to a plurality of targets.

The power source 1520 transmits wireless power to the first mobile 1540. In FIG. 15, power 1510 transmitted from the power source 1520 is represented as charging power. A shaded block in FIG. 15 labeled as charging power corresponds to an amount of charging power.

The power source 1520 continues to transmit a channel seizure signal 1521 indicating that a communication channel is being occupied.

Using a communication frequency of the communication channel, the power source 1520 transmits to the first mobile 1540 a charging information request signal 1522 and a state information signal 1523.

The charging information request signal 1522 is used to request charging information regarding a charging state of the first mobile 1540. For example, the charging information request signal 1522 is transmitted to request a voltage value and/or current value from an output terminal of the first mobile 1540.

The state information signal 1523 includes information indicating that the power source 1520 currently transmits the charging information request signal 1522 and is being operated in the charging mode. The state information signal 1523 may be stored in a portion of a packet.

In response, the power source 1520 receives an ACK from the first mobile 1540. The power source 1520 receives the charging information from the first mobile 1540. The power source 1520 also determines whether a load of the first mobile 1540 has changed.

When a predetermined period of time elapses, the power source 1520 transmits to the second mobile 1550 a charging information request signal 1524 and a state information signal 1525. In response, the power source 1520 receives an ACK from the second mobile 1550. The power source 1520 receives charging information regarding a charging state of the second mobile 1550 from the second mobile 1550. The power source 1520 also determines whether a load of the second mobile 1550 has changed.

The power source 1520 transmits a charging information request signal at regular intervals. When a response signal corresponding to the charging information request signal is not received from the first mobile 1540 for a predetermined period of time, the power source 1520 determines that the first mobile 1540 disappears from a wireless power transmission region of the power source 1520. The power source 1520 may determine that the first mobile 1540 disappears when a control ID request signal rather than the charging information request signal is transmitted to the first mobile 1540, and when a response signal corresponding to the control ID request signal is not received from the first mobile 1540.

The power source 1520 monitors power output from a power amplifier of the power source 1520. At 1511, when the output power changes, the power source 1520 transmits to the first mobile 1540 a charging information request signal 1526 and a state information signal 1527. Subsequently, the power source 1520 waits for a predetermined period of time until a response signal is received.

During a time T₂, the power source 1520 transmits a charging information request signal 1528 and a state information signal 1529. During this time, the power source 1520 also waits until response signals corresponding to the charging information request signal 1528 and the state information signal 1529 are received. During the time T₂, the power source 1520 transmits a charging information request signal 1531 and a state information signal 1532. During this time, the power source 1520 also waits until response signals corresponding to the charging information request signal 1531 and the state information signal 1532 are received. When a response signal is not received from the first mobile 1540 during the time T₂, the power source 1520 determines that the first mobile 1540 is not located in the wireless power transmission region of the power source 1520. In other words, the power source 1520 determines that the first mobile 1540 has disappeared.

When the first mobile 1540 is determined to have disappeared, the power source 1520 terminates the charging process. The power source 1520 turns off the wireless power transmission system and terminates the charging process.

When a predetermined period of time elapses, the power source 1520 transmits to the second mobile 1550, a charging information request signal 1533 and a state information signal 1534. In response, the power source 1520 receives an ACK from the second mobile 1550. The power source 1520 receives the charging information from the second mobile 1550, and determines that the load of the second mobile 1550 has changed.

For example, using an external sensor, the power source 1520 determines that the first mobile 1540 disappears and terminates the charging process.

In 1535, the power source 1520 adjusts power to be transmitted based on the charging information of the currently charged second mobile 1550. The power source 1520 transmits a state information signal 1536 notifying that the power to be transmitted is being adjusted. The power is adjusted by amount of power 1512 required to completely charge the load of the second mobile 1550. The power source 1520 transmits the adjusted power in operation 1537. The power source 1520 transmits a state information signal 1538 notifying that the adjusted power is being transmitted. The power source 1520 transmits to the second mobile 1550 a charging information request signal 1539 and a state information signal. In response, the power source 1520 receives an ACK from the second mobile 1550. The power source 1520 requests the charging information until the second mobile 1550 is completely charged.

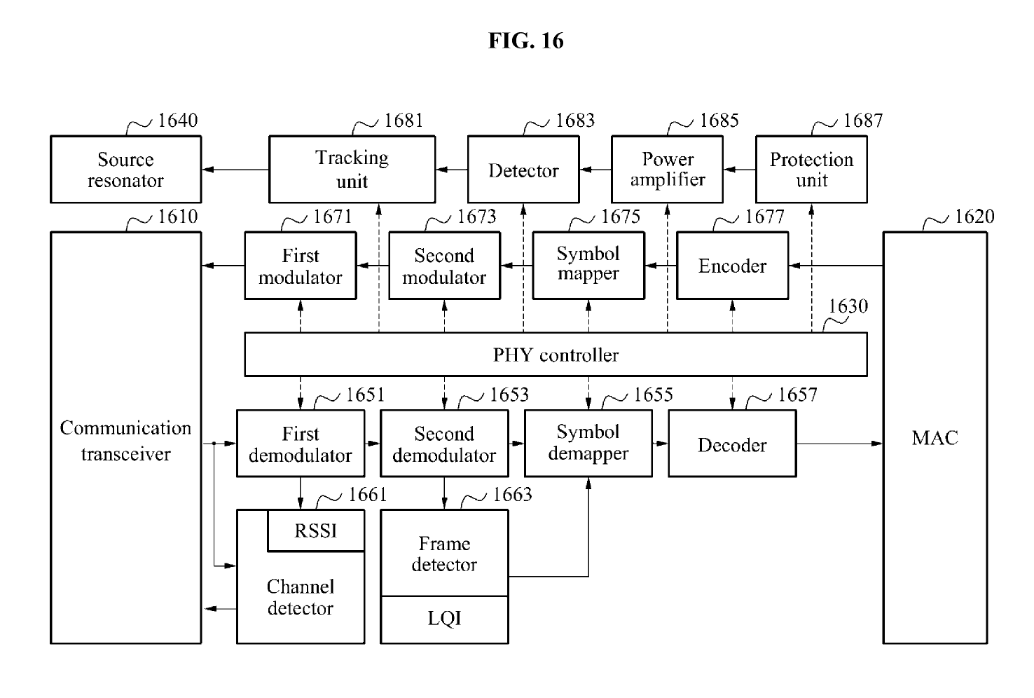

FIG. 16 is a block diagram illustrating still another example of a communication apparatus in the wireless power transmission system.

Referring to FIG. 16, the communication apparatus transmits a signal modulated in a source, through a communication transceiver 1610 and a MAC 1620, and may receive a signal modulated in a target. A PHY controller 1630 controls an overall operation associated with modulation of data and generation of wireless power in the communication apparatus. A source resonator 1640, for example a wireless power transmitter, transmits wireless power, using mutual resonance with a target resonator.

A first demodulator 1651, for example an offset-quadrature phase-shift keying (O-QPSK) demodulator, performs O-QPSK demodulation. A second demodulator 1653, for example a chip demodulator, performs demodulation using a pseudo noise (PN) sequence. A symbol demapper 1655 generates a data symbol corresponding to a quadrature-phase (Q) value and an in-phase (I) value. A decoder 1657, for example a Viterbi decoder, decodes the data symbol using a Viterbi scheme. The decoder 1657 uses a Viterbi algorithm to decode an encoded bit stream using forward error correction (FEC) based on a convolution code. The decoder 1657 is optional and may be removed from the communication apparatus of FIG. 16.

A channel detector 1661 detects an RSSI. The RSSI may refer to a value obtained by measuring strength of a signal transferred by neighboring devices. A frame detector 1663 detects an LQI of a communication link. The LQI may refer to quality between communication links and may be computed from the RSSI.

A first modulator 1671, for example an O-QPSK modulator, performs O-QPSK modulation. A second modulator 1673, for example a DSSS chip modulator, spreads data to a large-scale code flow occupying a full bandwidth of a corresponding channel, by multiplying a data bit by a random bit pattern, for example, a PN sequence. Among the many advantages of the configuration illustrated in FIG. 16, the configuration may have a good noise prevention performance, and may be excellent in security due to a difficulty to fetch data. A symbol mapper 1675 performs mapping to appropriately arrange symbols based on a designated modulation scheme. An encoder 1677, for example a convolution encoder, encodes an input signal and outputs the encoded signal. Among a number of advantages, the encoder 1677 successfully performs bit error checking using an additional bit. The encoder 1677 is optional and may be removed from the communication apparatus of FIG. 16.

A protection unit 1687 prevents overcurrent from being supplied to a power amplifier 1685. The power amplifier 1685 generates power required by the target. A detector 1683 detects a change in impedance of the target. Additionally, the detector 1683 detects power input to the power amplifier 1685. A tracking unit 1681 tracks matching impedance between the source and the target. Additionally, the tracking unit 1681 tracks a resonant frequency between the source and the target.

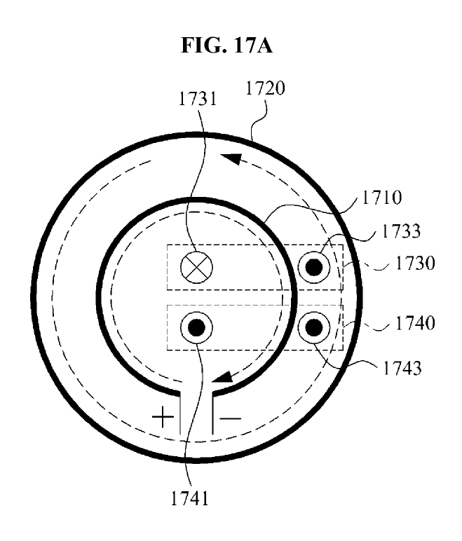

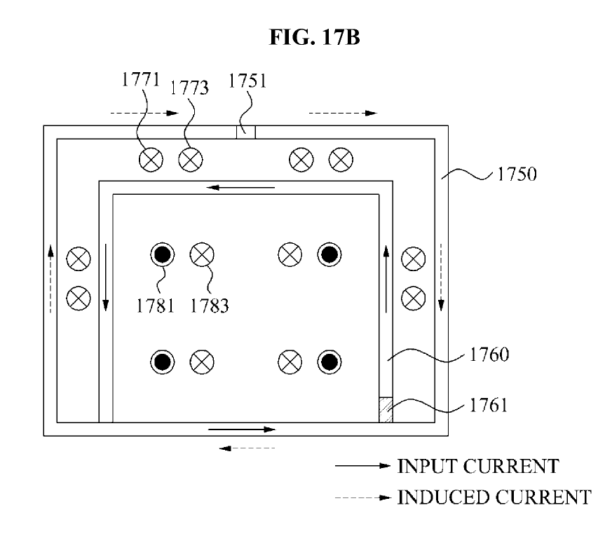

Hereinafter, the term “resonator” in FIGS. 17A through 19B may include, but it is not limited to, a source resonator and a target resonator.

FIGS. 17A and 17B illustrate examples of a distribution of a magnetic field in a feeder and a resonator.

When a resonator receives power supplied through a separate feeder, magnetic fields may be formed in both the feeder and the resonator.

Referring to FIG. 17A, as input current flows into a feeder 1710; a magnetic field 1730 may be formed. A direction 1731 of the magnetic field 1730 within the feeder 1710 includes a phase that is opposite to a phase of a direction 1733 of the magnetic field 1730 outside the feeder 1710. The magnetic field 1730 formed by the feeder 1710 causes induced current to be formed in a resonator 1720. The direction of the induced current is opposite to a direction of the input current.

Due to the induced current, a magnetic field 1740 is formed in the resonator 1720. Directions of a magnetic field formed due to induced current in all positions of the resonator 1720 may be the same. Accordingly, the resonator 1720 may form the magnetic field 1740 with a direction 1741 having the same phase as a direction 1743 of the magnetic field 1740. Consequently, when the magnetic field 1730 formed by the feeder 1710 and the magnetic field 1740 formed by the resonator 1720 are combined, a strength of a total magnetic field may decrease within the feeder 1710. However, the strength may increase outside the feeder 1710.

In an example in which power is supplied to the resonator 1720 through the feeder 1710 configured as illustrated in FIG. 17A, the strength of the total magnetic field may decrease in a center of the resonator 1720, but may increase outside the resonator 1720. In another example in which a magnetic field is randomly distributed in the resonator 1720, impedance matching may be difficult to perform because an input impedance may frequently vary. Additionally, when the strength of the total magnetic field is increased, an efficiency of wireless power transmission may be increased. Conversely, when the strength of the total magnetic field is decreased, the efficiency for wireless power transmission may be reduced. Accordingly, the power transmission efficiency may be reduced on average.

FIG. 17B illustrates an example of a structure of a wireless power transmitter in which a resonator 1750 and a feeder 1760 have a common ground. The resonator 1750 includes a capacitor 1751. The feeder 1760 receives as an input a radio frequency (RF) signal via a port 1761.

For example, when the RF signal is input to the feeder 1760, input current may be generated in the feeder 1760. The input current flowing in the feeder 1760 may cause a magnetic field to form. Also, the magnetic field may induce a current in the resonator 1750. Additionally, another magnetic field is formed due to the induced current flowing in the resonator 1750. In this example, a direction of the input current flowing in the feeder 1760 has a phase opposite to a phase of a direction of the induced current flowing in the resonator 1750. Accordingly, in a region between the resonator 1750 and the feeder 1760, a direction 1771 of the magnetic field formed due to the input current may have the same phase as a direction 1773 of the magnetic field formed due to the induced current. As a result, the strength of the total magnetic field may increase.

Conversely, within the feeder 1760, a direction 1781 of the magnetic field formed due to the input current may have a phase opposite to a phase of a direction 1783 of the magnetic field formed due to the induced current. As a result, the strength of the total magnetic field may decrease. Therefore, the strength of the total magnetic field may decrease in the center of the resonator 1750, but may increase outside the resonator 1750.

The feeder 1760 may determine an input impedance by adjusting an internal area of the feeder 1760. In one example, the input impedance refers to an impedance viewed in a direction from the feeder 1760 to the resonator 1750. When the internal area of the feeder 1760 is increased, the input impedance may be increased. Conversely, when the internal area of the feeder 1760 is reduced, the input impedance may be reduced. Because the magnetic field is randomly distributed in the resonator 1750, despite a reduction in the input impedance, a value of the input impedance may vary based on a location of a target device. Accordingly, a separate matching network may be required to match the input impedance to an output impedance of a power amplifier. For example, when the input impedance is increased, a separate matching network may be used to match the increased input impedance to a relatively low output impedance.

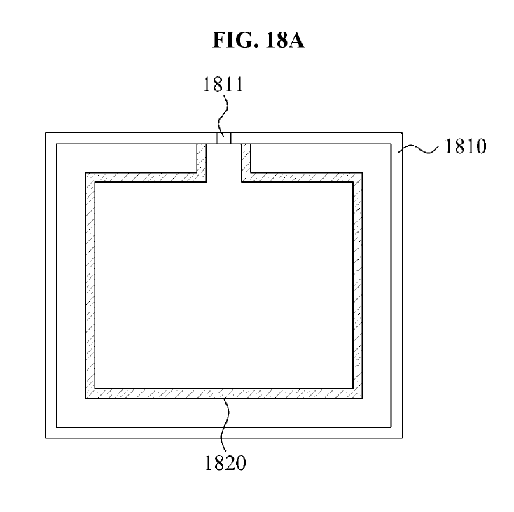

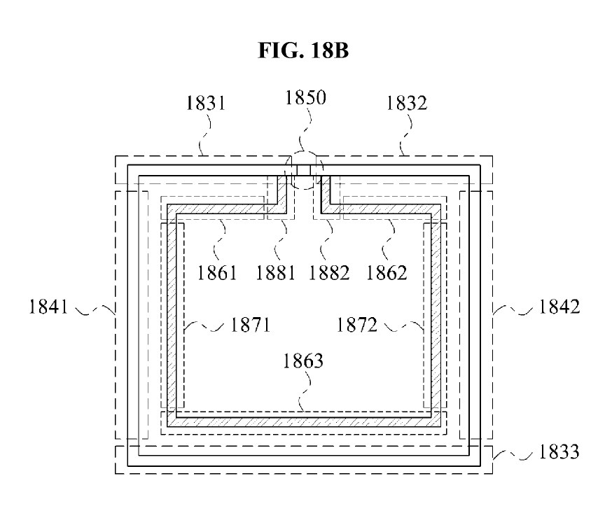

FIG. 18A illustrates an example of the wireless power transmitter.

Referring to FIG. 18A, the wireless power transmitter includes a resonator 1810, and a feeder 1820. The resonator 1810 also includes a capacitor 1811. The feeder 1820 is electrically connected to both ends of the capacitor 1811.

FIG. 18B illustrates, in more detail, a structure of the wireless power transmitter of FIG. 18A. The resonator 1810 includes a first transmission line, a first conductor 1841, a second conductor 1842, and at least one first capacitor 1850.

The first capacitor 1850 is inserted in series between a first signal conducting portion 1831 and a second signal conducting portion 1832 in the first transmission line. As a result, an electric field is confined within the first capacitor 1850. For example, the first transmission line includes at least one conductor in an upper portion of the first transmission line, and at least one conductor in a lower portion of the first transmission line. Current may flow through the at least one conductor disposed in the upper portion of the first transmission line. The at least one conductor disposed in the lower portion of the first transmission line may be electrically grounded. For example, a conductor disposed in an upper portion of the first transmission line may be separated into and referred to as the first signal conducting portion 1831 and the second signal conducting portion 1832. A conductor disposed in a lower portion of the first transmission line may be referred to as a first ground conducting portion 1833.

As illustrated in FIG. 18B, the resonator 1810 may have a generally two-dimensional (2D) structure. The first transmission line may include the first signal conducting portion 1831. An upper portion of the first transmission line includes the second signal conducting portion 1832. In addition, the first transmission line includes the first ground conducting portion 1833 in the lower portion of the first transmission line. The first signal conducting portion 1831 and the second signal conducting portion 1832 face the first ground conducting portion 1833. Current may flow through the first signal conducting portion 1831 and the second signal conducting portion 1832.

Additionally, one end of the first signal conducting portion 1831 is electrically connected (i.e., shorted) to the first conductor 1841. Another end of the first signal conducting portion 1831 is connected to the first capacitor 1850. One end of the second signal conducting portion 1832 is shorted to the second conductor 1842. Another end of the second signal conducting portion 1832 is connected to the first capacitor 1850. Accordingly, the first signal conducting portion 1831, the second signal conducting portion 1832, the first ground conducting portion 1833, and the conductors 1841 and 1842 are connected to each other, so that the resonator 1810 has an electrically closed-loop structure. The term “loop structure” includes, for example, a polygonal structure, such as a circular structure, a rectangular structure, and other similar types of structure. “Having a loop structure” may be used to indicate that the circuit is electrically closed.

The first capacitor 1850 is inserted into an intermediate portion of the first transmission line. For example, the first capacitor 1850 is inserted into a space between the first signal conducting portion 1831 and the second signal conducting portion 1832. The first capacitor 1850 is configured as a lumped element, a distributed element, and other similar types of elements. For example, a capacitor configured as a distributed element may include zigzagged conductor lines and a dielectric material, which includes a high permittivity positioned between the zigzagged conductor lines.

When the first capacitor 1850 is inserted into the first transmission line, the resonator 1810 includes a characteristic of a metamaterial. In one example, the metamaterial indicates a material having a predetermined electrical property that has not been discovered in nature and; thus, may have an artificially designed structure. An electromagnetic characteristic of the materials existing in nature may have a unique magnetic permeability or a unique permittivity. Most materials have a positive magnetic permeability or a positive permittivity.

In the case of most materials, a right hand rule may be applied to an electric field, a magnetic field, and a pointing vector. As a result, the corresponding materials may be referred to as right handed materials (RHMs). However, the metamaterial that has a magnetic permeability or a permittivity absent in nature may be classified into an epsilon negative (ENG) material, a mu negative (MNG) material, a double negative (DNG) material, a negative refractive index (NRI) material, a left-handed (LH) material, and other types of similar materials. Such classifications may be based on a polarity of the corresponding permittivity or magnetic permeability.

When a capacitance of the first capacitor 1850 inserted as the lumped element is determined, the resonator 1810 may have the characteristics of the metamaterial. Because the resonator 1810 may have a negative magnetic permeability by adjusting the capacitance of the first capacitor 1850, the resonator 1810 may also be referred to as an MNG resonator.

Various criteria may be applied to determine the capacitance of the first capacitor 1850. For example, the various criteria may include a criterion to enable the resonator 1810 to have the characteristic of the metamaterial, a criterion to enable the resonator 1810 to have a negative magnetic permeability in a target frequency, a criterion to enable the resonator 1810 to have a zeroth order resonance characteristic in the target frequency, and other similar types of criterions. Based on at least one criterion among the aforementioned criteria, the capacitance of the first capacitor 1850 may be determined.

The resonator 1810, also referred to as the MNG resonator 1810, includes a zeroth order resonance characteristic with a resonance frequency as a frequency when a propagation constant is “0”. Because the resonator 1810 may have a zeroth order resonance characteristic, the resonance frequency may be independent with respect to a physical size of the MNG resonator 1810. By appropriately designing or configuring the first capacitor 1850, the MNG resonator 1810 may sufficiently change the resonance frequency without changing the physical size of the MNG resonator 1810.

In a near field, for instance, the electric field may be concentrated on the first capacitor 1850 inserted into the first transmission line. Accordingly, as a result of the first capacitor 1850, the magnetic field may become dominant in the near field. The MNG resonator 1810 may have a relatively high Q-argument using the first capacitor 1850 of the lumped element, thereby enhancing an efficiency of power transmission. For example, the Q-argument may indicate a level of an ohmic loss or a ratio of a reactance with respect to a resistance in the wireless power transmission. The efficiency of the wireless power transmission may increase according to an increase in the Q-argument.

Although not illustrated in FIG. 18B, a magnetic core may be further provided to pass through the MNG resonator 1810. The magnetic core may increase a power transmission distance.

Referring to FIG. 18B, the feeder 1820 may include a second transmission line, a third conductor 1871, a fourth conductor 1872, a fifth conductor 1881, and a sixth conductor 1882.

The second transmission line includes a third signal conducting portion 1861 and a fourth signal conducting portion 1862 in an upper portion of the second transmission line. In addition, the second transmission line includes a second ground conducting portion 1863, in a lower portion of the second transmission line. The third signal conducting portion 1861 and the fourth signal conducting portion 1862 face the second ground conducting portion 1863. In the configuration of FIG. 18B, current flows through the third signal conducting portion 1861 and the fourth signal conducting portion 1862.

Additionally, one end of the third signal conducting portion 1861 is shorted to the third conductor 1871. Another end of the third signal conducting portion 1861 is connected to the fifth conductor 1881. One end of the fourth signal conducting portion 1862 is shorted to the fourth conductor 1872, and another end of the fourth signal conducting portion 1862 is connected to the sixth conductor 1882. The fifth conductor 1881 is connected to the first signal conducting portion 1831. The sixth conductor 1882 is connected to the second signal conducting portion 1832. The fifth conductor 1881 and the sixth conductor 1882 are connected in parallel to both ends of the first capacitor 1850. In this example, the fifth conductor 1881 and the sixth conductor 1882 are used as input ports to receive an RF signal as an input signal.

Accordingly, the third signal conducting portion 1861, the fourth signal conducting portion 1862, the second ground conducting portion 1863, the third conductor 1871, the fourth conductor 1872, the fifth conductor 1881, the sixth conductor 1882, and the resonator 1810 are connected to each other. As a result of such a configuration, the resonator 1810 and the feeder 1820 have an electrically closed-loop structure. The term “loop structure” may include, for example, a polygonal structure such as a circular structure, a rectangular structure, and other similar type of structure. When an RF signal is received via the fifth conductor 1881 or the sixth conductor 1882, input current flows in the feeder 1820 and the resonator 1810. A magnetic field is formed due to the input current, and the formed magnetic field induces a current to the resonator 1810. A direction of the input current flowing in the feeder 1820 may be the same as a direction of the induced current flowing in the resonator 1810. As a result, a strength of the total magnetic field may increase in the center of the resonator 1810, but may decrease outside the resonator 1810.

An input impedance may be determined based on an area of a region between the resonator 1810 and the feeder 1820. Accordingly, a separate matching network to match the input impedance to an output impedance of a power amplifier may not be required or necessary. For example, even when the matching network is used, the input impedance may be determined by adjusting a size of the feeder 1820. As a result, a structure of the matching network is simplified. The simplified structure of the matching network minimizes a matching loss of the matching network.

The second transmission line, the third conductor 1871, the fourth conductor 1872, the fifth conductor 1881, and the sixth conductor 1882 form the same structure as the resonator 1810. In an example in which the resonator 1810 has a loop structure, the feeder 1820 also has a loop structure. In another example in which the resonator 1810 has a circular structure, the feeder 1820 also has a circular structure.

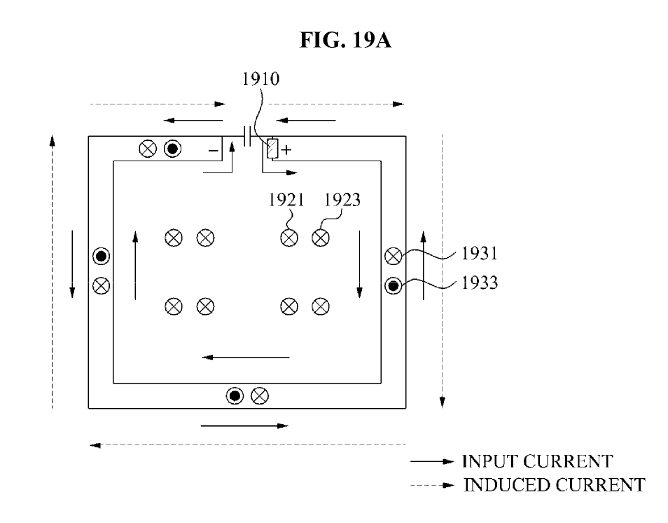

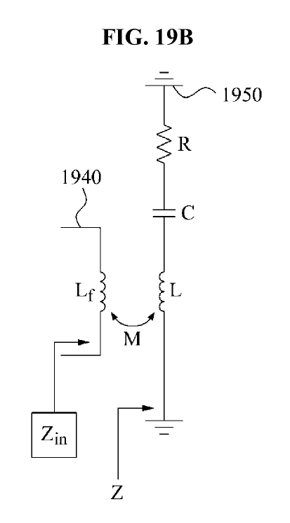

FIG. 19A illustrates an example of a distribution of a magnetic field within the resonator based on feeding to the feeder. In other words, FIG. 19A more briefly illustrates the resonator 1810 and the feeder 1820 of FIG. 18A. FIG. 19B illustrates one equivalent circuit of a feeder 1940 and one equivalent circuit of a resonator 1950.

A feeding operation may refer to supplying power to a source resonator in wireless power transmission, or refer to supplying AC power to a rectifier in a wireless power transmission. FIG. 19A illustrates a direction of input current flowing in the feeder, and a direction of induced current induced in the source resonator. Additionally, FIG. 19A illustrates a direction of a magnetic field formed due to the input current of the feeder, and a direction of a magnetic field formed due to the induced current of the source resonator.

Referring to FIG. 19A, the fifth conductor 1881 or the sixth conductor 1882 of the feeder 1820 are used as an input port 1910. The input port 1910 receives an RF signal as an input. The RF signal is output from a power amplifier. The power amplifier increases or decreases an amplitude of the RF signal based on a demand by a target device. The RF signal received at the input port 1910 is displayed in the form of input current flowing in the feeder. The input current flows in a clockwise direction in the feeder, along a transmission line of the feeder. The fifth conductor of the feeder is electrically connected to the resonator. More specifically, the fifth conductor is connected to a first signal conducting portion of the resonator. Accordingly, the input current flows in the resonator, as well as, in the feeder. The input current flows in a counterclockwise direction in the resonator. The input current flowing in the resonator causes a magnetic field to be formed, so that induced current is generated in the resonator due to the magnetic field. The induced current flows in a clockwise direction in the resonator. For example, the induced current transfers energy to a capacitor of the resonator, and a magnetic field is formed due to the induced current. In this example, the input current flowing in the feeder and the resonator is indicated by a solid line of FIG. 19A, and the induced current flowing in the resonator is indicated by a dotted line of FIG. 19A.

A direction of a magnetic field formed due to a current may be determined based on the right hand rule. As illustrated in FIG. 19A, within the feeder, a direction 1921 of a magnetic field formed due to the input current flowing in the feeder is identical to a direction 1923 of a magnetic field formed due to the induced current flowing in the resonator. Accordingly, the strength of the total magnetic field increases within the feeder.

Additionally, as illustrated in FIG. 19A, in a region between the feeder and the resonator, a direction 1933 of a magnetic field, formed due to the input current flowing in the feeder, has a phase opposite to a phase of a direction 1931 of a magnetic field, which is formed due to the induced current flowing in the source resonator. Accordingly, the strength of the total magnetic field decreases in the region between the feeder and the resonator.

Typically, a strength of a magnetic field decreases in the center of a resonator with the loop structure and increases outside the resonator. However, referring to FIG. 19A, the feeder may be electrically connected to both ends of a capacitor of the resonator and, accordingly, the induced current of the resonator flows in the same direction as the input current of the feeder. Because the induced current of the resonator flows in the same direction as the input current of the feeder, the strength of the total magnetic field increases within the feeder, and decreases outside the feeder. As a result, the strength of the total magnetic field increases in the center of the resonator with the loop structure, and decreases outside the resonator, due to the feeder. Thus, the strength of the total magnetic field may be equalized within the resonator.

The power transmission efficiency to transfer a power from the resonator to a target resonator may be in proportion to a strength of a total magnetic field formed in the resonator. In other words, when the strength of the total magnetic field increases in the center of the resonator, the power transmission efficiency also increases.

Referring to FIG. 19B, the feeder 1940 and the resonator 1950 may be expressed as equivalent circuits. An example of an input impedance Zᵢₙ viewed in a direction from the feeder 1940 to the resonator 1950 is computed, as given in Equation 4.

$${Z}_{in} = \frac{{( ω M )}^{2}}{Z} \qquad [ Equation 4 ]$$

In Equation 4, M denotes a mutual inductance between the feeder 1940 and the resonator 1950, w denotes a resonance frequency between the feeder 1940 and the resonator 1950, and Z denotes an impedance viewed in a direction from the resonator 1950 to a target device. The input impedance Zᵢₙ may be in proportion to the mutual inductance M. Accordingly, the input impedance Zᵢₙ may be controlled by adjusting the mutual inductance M. The mutual inductance M may be adjusted based on an area of a region between the feeder 1940 and the resonator 1950. The area of the region between the feeder 1940 and the resonator 1950 may be adjusted based on a size of the feeder 1940. Accordingly, the input impedance Zᵢₙ may be determined based on the size of the feeder 1940 and, thus, a separate matching network may not be required or necessary to perform impedance matching with an output impedance of a power amplifier.

In a target resonator and a feeder that are included in a wireless power receiver, a magnetic field may be distributed as illustrated in FIG. 19A. For example, the target resonator receives wireless power from a source resonator through magnetic coupling. Due to the received wireless power, induced current is generated in the target resonator. A magnetic field formed due to the induced current in the target resonator causes another induced current to be generated in the feeder. In this example, when the target resonator is connected to the feeder as illustrated in FIG. 19A, the induced current generated in the target resonator flows in the same direction as the induced current generated in the feeder. Thus, the strength of the total magnetic field increases within the feeder, but decreases in a region between the feeder and the target resonator.

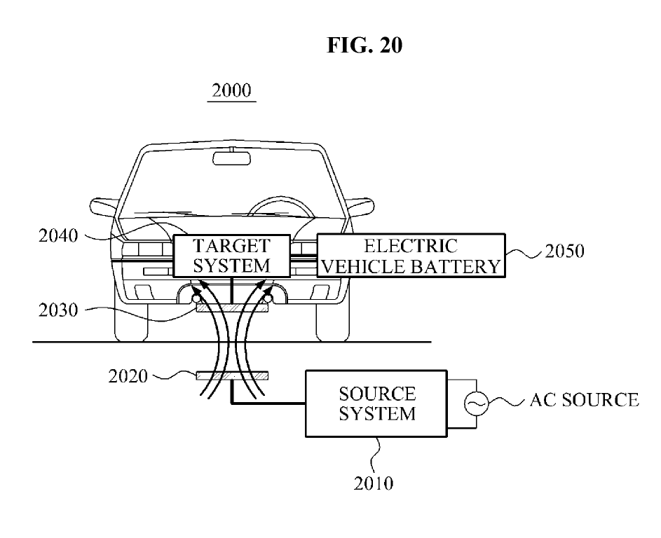

FIG. 20 illustrates an example of an electric vehicle charging system.

Referring to FIG. 20, an electric vehicle charging system 2000 includes a source system 2010, a source resonator 2020, a target resonator 2030, a target system 2040, and an electric vehicle battery 2050.

The electric vehicle charging system 2000 may have a similar structure to the wireless power transmission system of FIG. 1. The source system 2010 and the source resonator 2020 in the electric vehicle charging system 2000 function as a source. Additionally, the target resonator 2030 and the target system 2040 in the electric vehicle charging system 2000 function as a target.

The source system 2010 includes a variable SMPS, a power amplifier, a matching network, a controller, and a communication unit, similarly to the source 110 of FIG. 1. The target system 2040 includes a matching network, a rectifier, a DC/DC converter, a communication unit, and a controller, similarly to the target 120 of FIG. 1.

The electric vehicle battery 2050 is charged with the target system 2040.

The electric vehicle charging system 2000 uses a resonant frequency in a band of a few kilohertz (KHz) to tens of MHz.

The source system 2010 generates power based on a type of charging vehicle, a capacity of a battery, and a charging state of a battery. The source system 2010 also supplies the generated power to the target system 2040.

The source system 2010 controls the source resonator 2020 and the target resonator 2030 to be aligned. For example, when the source resonator 2020 and the target resonator 2030 are not aligned, the controller of the source system 2010 transmits a message to the target system 2040, and controls alignment between the source resonator 2020 and the target resonator 2030.

For example, when the target resonator 2030 is not located in a position enabling maximum magnetic resonance, the source resonator 2020 and the target resonator 2030 may not be aligned. When a vehicle does not stop accurately over the source resonator 2020, the source system 2010 induces a position of the vehicle to be adjusted. The source system 2010 also controls the source resonator 2020 and the target resonator 2030 to be aligned.

The source system 2010 and the target system 2040 transmit or receive an ID of a vehicle, or may exchange various messages, through communication between the source resonator 2020 and the target resonator 2030.

The descriptions of FIGS. 2 through 19B may be applied to the electric vehicle charging system 2000. However, the electric vehicle charging system 2000 may use a resonant frequency in a band of a few KHz to tens of MHz, and may transmit power that is equal to or higher than tens of watts to charge the electric vehicle battery 2050.

As described above, according to various embodiments or configurations, in a wireless power transmission system, a target may receive a state information signal associated with a communication channel from a source. While searching for the communication channel, the source may determine a state of the communication channel based on the received state information signal and may determine whether the communication channel is available.

Additionally, according to various embodiments, in a wireless power transmission system, a source may continue to receive information from a load of a target, and may efficiently compute an amount of power to be transmitted.

Furthermore, according to various embodiments, in a wireless power transmission system, a source may transmit an access standard instruction. When a response signal is received from a target satisfying an access standard, the source may assign a control ID to the target. Thus, among various advantages of the present embodiments, it is possible to prevent the source and the target from colliding with each other when the target accesses the source.

As a non-exhaustive illustration only, the communication unit described herein may be a mobile device, such as a cellular phone, a personal digital assistant (PDA), a digital camera, a portable game console, an MP3 player, a portable/personal multimedia player (PMP), a handheld e-book, a portable laptop PC, a global positioning system (GPS) navigation device, a tablet, a sensor, or a stationary device, such as a desktop PC, a high-definition television (HDTV), a DVD player, a Blue-ray player, a set-top box, a home appliance, or any other device known to one of ordinary skill in the art that is capable of wireless communication and/or network communication.

The methods or operations according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts.

Software or instructions for controlling a source or a target to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A communication apparatus in a wireless power transmission system, the communication apparatus comprising:
a communication unit configured to transmit a state information signal using a frequency of a communication channel, wherein the communication channel is selected from channels excluding a channel used in wireless power transmission, and the state information signal comprises an operating mode of a source; and
a controller configured to determine a control identifier (ID) of a target when a response signal corresponding to an access standard instruction is received from the target.

2. The communication apparatus of claim 1, wherein the communication unit is further configured to transmit a channel seizure signal and the access standard instruction using the frequency of the communication channel, wherein the channel seizure signal comprises a continuous wave (CW) signal at a magnitude and power higher than a signal of a direct-sequence spread spectrum (DSSS).

3. The communication apparatus of claim 2, wherein the communication unit continues to transmit the channel seizure signal until a communication with the target is terminated.

4. The communication apparatus of claim 1, wherein the communication unit is further configured to transmit the determined control ID to the target, receive a response signal indicating reception of the determined control ID from the target, transmit a target information request signal to request information from the target, and receive a target information response signal including the information from the target.

5. The communication apparatus of claim 4, wherein the controller is further configured to determine an initial wireless power to be transmitted to the target based on the information from the target and information on an efficiency of a source resonator.

6. The communication apparatus of claim 5, further comprising:
a power transmitter to wirelessly transmit the determined initial wireless power through a magnetic coupling between the source resonator and a target resonator.

7. The communication apparatus of claim 6, wherein the communication unit is further configured to transmit a charging information request signal to request information regarding a power transferred to a load at the target, and receive, from the target a charging information response signal including the information regarding the transferred power.

8. The communication apparatus of claim 7, wherein the controller is further configured to compare the information regarding the transferred power with a power required by the load at the target, and determine a power to be transmitted to the target based on the information on the efficiency of the source resonator.

9. The communication apparatus of claim 6, wherein, when the target is detected in a wireless power transmission region of the source, the power transmitter transmits a wake-up power required for communication with the target.

10. The communication apparatus of claim 1, wherein the communication unit is further configured to transmit a wireless power transmission frame, and
wherein a frame payload of a medium access control (MAC) layer of the wireless power transmission frame includes a start of text (STX) field, a source (SRC) field, a destination (DST) field, a command (CMD) field, a length (LEN) field, a data field, an end of text (ETX) field, and a checksum (CS) field.

11. The communication apparatus of claim 10, wherein the CMD field includes at least one of a target reset instruction, an input voltage/current request instruction, an output voltage/current request instruction, a target state request instruction, a target charging control instruction, an access standard instruction, a control ID assignment instruction, a target system configuration block (SCB) information request instruction, and a channel change request instruction.

12. The communication apparatus of claim 1, wherein the controller is further configured to detect a change in a power output from a power amplifier included in the source, and determines that the load at the target has changed, and
wherein the communication unit is further configured to transmit a charging information request signal to request information regarding a power transferred to the load at the target, and receive, from the target, a charging information response signal including the information regarding the transferred power.

13. The communication apparatus of claim 12, wherein, when charging of the load is complete, the controller is further configured to generate a target charging control signal to open electrical connection between the target and the load to prevent additional power from being transferred to the load.

14. The communication apparatus of claim 1, wherein the controller is further configured to determine whether the target is located in the wireless power transmission region of the source based on whether a response signal is received in response to a charging information request signal transmitted in real time to the target.

15. The communication apparatus of claim 12, wherein, when the controller detects the change in the power output from the power amplifier in the source is detected, the controller is further configured to attempt to communicate with the target and determine that the target is located in the wireless power transmission region when a response signal is received from the target.

16. The communication apparatus of claim 1, wherein, when a movement of the target is detected by an external sensor, the controller is further configured to attempt to communicate with the target, and determine that the target is located in the wireless power transmission region when a response signal is received from the target.

17. The communication apparatus of claim 1, wherein, when a power is supplied, the controller is further configured to perform basic hardware initialization, reads information from a system configuration block (SCB), acquire information, which comprises a serial number of the source, a maximum number of targets accessible to the source, a power transmission parameter, and a frequency search channel, and control a communication output in the frequency search channel.

18. The communication apparatus of claim 17, wherein the SCB comprises a region indicating a manufacturer of a product, a region used to classify products into a source and a target, a region indicating a unique ID of a product, a region indicating a model type, and a region indicating a serial number.

19. The communication apparatus of claim 1, wherein the controller is further configured to control the source and the target to be operated in a master mode and a slave mode, respectively.

20. The communication apparatus of claim 1, wherein, when a channel accessed by the source has changed to another channel due to interference with the channel, the communication unit is further configured to transmit to the target a broadcasting instruction not requiring a response signal from the target so that the target changes a channel to the other channel.

21. The communication apparatus of claim 1, further comprising:
a first light-emitting diode (LED) indicator, a second LED indicator, and a third LED indicator, each displaying different colors,
wherein, when a power is supplied to the source and when hardware initialization is normally performed, the first LED indicator is turned on,
wherein, when the hardware initialization is abnormally performed or when abnormality occurs in an operation of the source, the second LED indicator flickers,
wherein, when the target is being charged by the source, the second LED indicator is turned on, and
wherein, when a communication error between the source and the target occurs, the third LED indicator flickers.

22. A communication apparatus in a wireless power transmission system, the communication apparatus comprising:
a communication unit configured to receive a channel seizure signal, an access standard instruction, and a state information signal using a frequency of a communication channel, and to transmit a response signal corresponding to the access standard instruction, wherein the state information signal comprises an operating mode of a source; and
a controller configured to determine the communication channel to be a channel used for communication between the source and a target based on the received channel seizure signal, and to generate a response signal corresponding to the access standard instruction.

23. The communication apparatus of claim 22, wherein, when a communication being performed between the source and another target in an access mode or a charging mode is verified based on the state information signal, the controller is further configured to wait for communication with another source.

24. The communication apparatus of claim 22, wherein the communication unit is further configured to receive a control identifier (ID) from the source, transmit a response signal indicating reception of the control ID, receive a target information request signal to request target information, and transmit a target information response signal including the target information.

25. The communication apparatus of claim 24, further comprising:
a power receiving unit configured to wirelessly receive an initial wireless power through a magnetic coupling between a source resonator and a target resonator, wherein the initial wireless power is determined based on the target information.

26. The communication apparatus of claim 22, wherein, when the controller determines that charging of a load at the target is determined to be complete, the controller is further configured to open an electrical connection between the target and the load to prevent a power from being transferred to the load.

27. The communication apparatus of claim 22, when the controller is awakes, the controller is further configured to perform basic hardware initialization, and acquire a serial number of a target, a battery type, a power transmission parameter, and a parameter of a search channel from a system configuration block (SCB).

28. The communication apparatus of claim 22, further comprising:
a first light-emitting diode (LED) indicator, a second LED indicator, and a third LED indicator, each displaying different colors,
wherein, when a wake-up power is supplied to the target and when hardware initialization is normally performed, the first LED indicator is turned on,
wherein, when the hardware initialization is abnormally performed or when abnormality occurs in an operation of the target, the second LED indicator flickers,
wherein, when the target is being charged, the second LED indicator is turned on, and
wherein, when a communication error between the source and the target occurs, the third LED indicator flickers.

29. A communication apparatus in a wireless power transmission system, the communication apparatus comprising:
a communication unit configured to transmit a channel seizure signal, a first access standard instruction, and a first state information signal using a frequency of a communication channel, wherein the communication channel is selected from channels excluding a channel used in wireless power transmission, and the first state information signal comprises an operating mode of a source; and
a controller configured to receive a response signal corresponding to the first instruction from a first target to determine a control identifier (ID) of the first target,
wherein, when the determined control ID of the first target is transmitted, the communication unit is further configured to transmit the channel seizure signal, a second access standard instruction, and a second state information signal using the frequency of the communication channel, and
wherein, when a response signal corresponding to the second access standard instruction is received from a second target, the controller is further configured to determine a control ID of the second target.

30. The communication apparatus of claim 29, wherein the communication unit is further configured to transmit a first charging information request signal to request information regarding a power transferred to a load of the first target, and receive from the first target a first charging information response signal including the information regarding the transferred power, and
wherein, when the first charging information response signal is received, the communication unit is further configured to transmit a second charging information request signal to request information regarding a power transferred to a load of the second target, and receive, from the second target, a second charging information response signal including the information regarding the transferred power.

31. The communication apparatus of claim 30, wherein the communication unit is further configured to
transmit the first charging information request signal, together with a third state information signal indicating that the source is operated in a charging mode to transmit a power to the first target, and
transmit the second charging information request signal, together with a fourth state information signal indicating that the source is operated in the charging mode to transmit a power to the second target.

32. The communication apparatus of claim 30, wherein the controller is further configured to
compare the information regarding the power transferred to the load of the first target with a power required by the load of the first target,
compare the information regarding the power transferred to the load of the second target with a power required by the load of the second target, and
determine a power to be transmitted.

33. A communication method for a wireless power transmission system, the communication method comprising:
selecting a communication channel from channels excluding a channel used in wireless power transmission,
transmitting a state information signal using a frequency of a communication channel, wherein the state information signal comprises an operating mode of a source; and
determining a control identifier (ID) of a target when a response signal corresponding to an access standard instruction is received from the target.

34. The communication method of claim 33, further comprising:
configuring a channel seizure signal to comprise a continuous wave (CW) signal at a magnitude and power higher than a signal of a direct-sequence spread spectrum (DSSS); and
transmitting the channel seizure signal and the access standard instruction using the frequency of the communication channel.

35. The communication method of claim 34, further comprising:
continuously transmitting the channel seizure signal until a communication with the target is terminated.

36. The communication method of claim 33, further comprising:
transmitting the determined control ID to the target;
receiving a response signal indicating reception of the determined control ID from the target;
transmitting a target information request signal to request information from the target; and
receiving a target information response signal including the information from the target.

37. The communication method of claim 36, further comprising:
determining an initial wireless power to be transmitted to the target based on the information from the target and information on an efficiency of a source resonator.

38. The communication method of claim 37, further comprising:
wirelessly transmitting the determined initial wireless power through a magnetic coupling between the source resonator and a target resonator.

39. The communication method of claim 38, further comprising:
transmitting a charging information request signal to request information regarding a power transferred to a load at the target; and
receiving from the target a charging information response signal including the information regarding the transferred power.

40. The communication method of claim 39, further comprising:
comparing the information regarding the transferred power with a power required by the load at the target; and
determining a power to be transmitted to the target based on the information on the efficiency of the source resonator.

41. The communication method of claim 38, further comprising:
transmitting a wake-up power to communicate with the target when the target is detected in a wireless power transmission region of the source.

42. The communication method of claim 33, further comprising:
detecting a change in a power output from a power amplifier included in the source, and determines that the load at the target has changed;
transmitting a charging information request signal to request information regarding a power transferred to the load at the target; and
receiving, from the target, a charging information response signal including the information regarding the transferred power.

43. The communication method of claim 33, further comprising:
when charging of the load is complete, generating a target charging control signal to open electrical connection between the target and the load to prevent additional power from being transferred to the load.

44. The communication method of claim 33, further comprising:
determining whether the target is located in the wireless power transmission region of the source based on whether a response signal is received in response to a charging information request signal transmitted in real time to the target.

45. The communication method of claim 33, further comprising:
when the controller detects the change in the power output from the power amplifier in the source is detected, attempting to communicate with the target, and determining that the target is located in the wireless power transmission region when a response signal is received from the target.

46. The communication method of claim 33, further comprising:
when a movement of the target is detected by an external sensor, attempting to communicate with the target, and determining that the target is located in the wireless power transmission region when a response signal is received from the target.

47. The communication method of claim 33, further comprising:
when a channel accessed by the source has changed to another channel due to interference with the channel, transmitting to the target a broadcasting instruction not requiring a response signal from the target so that the target changes a channel to the other channel.
